(19) United States
(12) Patent Application Publication
(10) Pub. No.: US 2014/0108251 A1
(43) Pub. Date: Apr. 17, 2014

(54) Collaborative Fraud Determination And Prevention

(71) Applicants: Robert Whitney Anderson, New York, NY (US); Cathy Ross, New York, NY (US)

(72) Inventors: Robert Whitney Anderson, New York, NY (US); Cathy Ross, New York, NY (US)

(21) Appl. No.: 14/042,878

(22) Filed: Oct. 1, 2013

Related U.S. Application Data
(60) Provisional application No. 61/708,154, filed on Oct. 1, 2012.

(51) Int. Cl. G06Q 20/40

(52) U.S. Cl. CPC G06Q 20/4016
USPC 705/44

(57) ABSTRACT

A computer implemented method and system for determining a fraudulent payment transaction in a collaborative environment is provided. A collaborative database, accessible by multiple reviewing entities via a network, receives and stores transaction history data of payment transactions from the reviewing entities. A collaborative fraud prevention platform (CFPP) receives a fraud determination query associated with a transaction request associated with a consumer account. The CFPP performs a search in the collaborative database based on the fraud determination query by comparing current transaction data from the transaction request with the stored transaction history data, performs an analysis of characteristics of the consumer account, and generates a fraud determination report based on the comparison and analysis. The fraud determination report indicates authenticity or non-authenticity of the transaction request for configurable time periods to enable a reviewing entity to determine the fraudulent payment transaction and complete or discontinue processing of the transaction request.

### CROSS REFERENCE TO RELATED APPLICATIONS

This application claims the benefit of provisional patent application No. 61/708,154 titled “Method and System for Collaborative or Crowdsourced Fraud Prevention”, filed in the United States Patent and Trademark Office on Oct. 1, 2012.

The specification of the above referenced patent application is incorporated herein by reference in its entirety.

### BACKGROUND

Fraud continues to plague the retail industry with more than $100 billion losses over the past year as per the 2012 LexisNexis® fraud report. To make the problem even more acute, for every $100 lost in fraudulent payment transactions, merchant entities such as retailers incurred losses attributed by additional labor, bank and related costs of $130 according to the 2012 CyberSource® fraud report. Moreover, after rejecting non-fraudulent transaction orders of an additional $280 for fear of fraud, the total cost of fraud reached $510. In 2011, according to market research reports, on a percentage basis, an average internet merchant entity suffered direct losses of 1.0% and a total loss averaging 5.1% of total sales. Furthermore, the most lucrative areas of growth for merchant entities in various fields, for example, the international industry, the mobile industry, the electronic commerce (e-commerce) industry, etc., are also most susceptible to fraud.

Payment methods are rapidly evolving as consumers increasingly use the internet for shopping, entertainment, and a wide variety of other activities which require funds to be transferred. The merchant entities are also able to reach beyond traditional geographical boundaries to find new consumers and provide new offerings. Moreover, many experts estimate that as much as 90% of ill-gotten proceeds from internet fraud, amounting to billions of dollars, end up in the hands of organized crime. As such, there are large benefits that will emerge by keeping those funds with the merchant entities and away from the criminals for society at large.

There are two types of fraud defined in the retail industry, namely, hard fraud and soft fraud. Hard fraud occurs when a party deliberately plans or invents a loss such as a collision, automobile theft, fire, etc., that is covered by their insurance policy in order to receive payment for the damages. Soft fraud includes exaggeration of otherwise legitimate claims by policyholders. For example, when involved in a collision, an insured person may claim more damage than that was really done to his or her car. Soft fraud can also occur when, while obtaining a new insurance policy, an individual misreports previous or existing conditions in order to obtain a lower premium on their insurance policy.

The major fraud prevention systems prevalent today are developed primarily for, and usually by, credit card processing and management services and financial institutions. The information associated with payment transactions submitted by merchant entities is primarily used by these credit card processing and management services and financial institutions for financial settlement purposes. The payment transaction information is then re-purposed by these fraud prevention systems for fraud prevention at an extra cost to the merchant entity. These fraud prevention systems which target hard fraud are inadequate from a merchant entity's perspective as evidenced by a fact that 60% of detected fraud is soft fraud. Moreover, the merchant entities experience 85% of all the fraud losses caused by retail fraud. Specifically, these fraud prevention systems are engineered to minimize transactional risk for online payment management entities, for example, credit card associations, credit card issuers, payment processors, payment gateways, acquiring banks, etc., and to protect the interests of their individual credit card consumers. The other party in every online payment transaction, that is, the merchant entity has had to rely on ad-hoc and inadequate systems to mitigate its harmful exposure to online payment fraud, and has not had a system developed and made commercially available for its exclusive benefit. This is evidenced by the fact that 85% of all fraud related losses over the past year have been borne by the merchant entities, according the 2012 LexisNexis® Risk Solutions fraud report. The fraud report includes multiple research results, for example, total merchant fraud losses are nearly ten times those incurred by financial institutions, merchant fraud losses are more than twenty times the cost incurred by consumers, and credit card transaction crimes continue to rise sharply, and alternative payments are starting to represent a troubling new source of losses for large merchant entities.

In the present day scenario, a fraudster submits a fraudulent payment transaction request to a merchant entity via a graphical user interface of the merchant entity's web service. The merchant entity believes this fraudulent payment transaction request initially to be a genuine order. The merchant entity submits order data from the received fraudulent payment transaction request to a payment gateway or a credit card processing service for processing through an acquiring bank, a credit card processor, etc. The payment gateway transmits an approval message associated with the fraudulent payment transaction request to the merchant entity, verifying the authenticity of a consumer account used by the fraudster to place the fraudulent payment transaction request. On receiving confirmation from the payment gateway, the merchant entity processes the fraudulent payment transaction and ships the order, thereby falling prey to the fraud and losing money. There is a need for a fraud prevention system that maintains a track of such fraudulent payment transactions experienced by merchant entities and notifies them in real time before processing another fraudulent payment transaction.

Moreover, despite all the anti-fraud systems and technologies that have been developed to date, more than 1 in 4 online payment orders are still manually reviewed by online merchant entities, requiring substantial resources that could be deployed more productively elsewhere. Furthermore, the time taken for payment fraud to be detected and reported by innocent cardholders after receiving and reviewing his/her statements typically is about 30 days to about 45 days. Within each of the merchant entities' organizations, there are generally staff members dedicated to perform manual screening of suspicious online payment orders. There are likely other staff members that concentrate on the management of returns and associated credits, another group that concentrates on charge backs and fraud claims, and consumer service representatives that typically handle the consumers whose credit cards have been misused. All these resources can be deployed more productively elsewhere with the introduction of a more efficient fraud prevention system, so that each of resources employed in multiple departments can be used to more quickly and reliably identify which orders are fraudulent, and to more efficiently process the remaining non-fraudulent orders.

There is a need for a fraud prevention system that benefits the merchant entities that process international, mobile and e-commerce transactions as well as those merchant entities that accept new, emerging and alternative methods of payments such as virtual currencies, mobile wallets, etc., by pooling data associated with known fraudulent and problematic payment transactions from many merchant entities, for each of the merchant entity's own benefit. This pooled data need not be shared with the credit card processing and management services and financial institutions, as this pooled data will be known by the merchant entities only after the fraudulent payment transaction is processed by the merchant entities. Furthermore, fraudsters these days have become highly tech-savvy and have learned to test, deconstruct and circumvent algorithms of current fraud prevention systems. Approximately 20% of fraudulent payment transactions successfully evade the current fraud prevention systems and processes employed by merchant entities. There is also a need for a fraud prevention system that is a fail-safe version of the fraud prevention systems used by the merchant entities, which target “tough-to-detect” fraudulent payment transactions.

Hence, there is a long felt but unresolved need for a computer implemented method and system that enables merchant entities to pool and share data associated with real time fraudulent payment transactions in a collaborative environment in order to prevent a substantial percentage of losses incurred by the merchant entities due to fraudulent payment transactions. Moreover, there is a need for a computer implemented method and system that generates a collaborative and a crowd sourced database of known fraudulent payment transaction data files, suspicious payment transaction data files based on an analysis of known fraudulent payment transactions, and known non-fraudulent payment transaction data files obtained from shared online transaction data files submitted by the merchant entities, that helps the merchant entities across all industries in determining fraudulent payment transactions and separating received online transaction orders into a non-fraudulent transaction category, a fraudulent transaction category, and a suspicious transaction category. Furthermore, there is a need for a computer implemented method and system that generates a database to store a history of non-fraudulent orders to facilitate expeditious, efficient, and accurate processing of online payment orders so that the merchant entities can rely not only on their own data files of known fraudulent orders, but also on the combined data files of hundreds or thousands of merchant entities whose collective experience is vastly more accurate, beneficial, and useful in stopping fraud online and in their stores, thereby improving the shopping experience for legitimate consumers. Furthermore, there is a need for a computer implemented method and system that allows merchant entities to timely share fraudulent order data files across all types of devices from which the fraudulent orders are submitted, so that a massive new stream of real time information can be tapped to potentially prevent half of the current fraud experienced by merchant entities.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for enabling merchant entities to pool and share data associated with real time fraudulent payment transactions in a collaborative environment in order to prevent a substantial percentage of losses incurred by merchant entities due to fraudulent payment transactions. As used herein, the term “fraudulent payment transaction” refers to a financial transaction initiated by a fraudulent entity, herein referred to as a “fraudster” in disguise of a consumer for fraudulently purchasing a product and/or a service provided by a merchant entity. Also, as used herein, the term “collaborative environment” refers to an environment in which multiple merchant entities crowd source their data banks of transaction history data corresponding to purchases of products and/or services by consumers from the merchant entities to facilitate fraud determination and prevention. The computer implemented method and system disclosed herein generates a collaborative and a crowd sourced database of known fraudulent payment transaction data files, suspicious payment transaction data files based on an analysis of known fraudulent payment transactions, and known non-fraudulent payment transaction data files obtained from shared online transaction data files submitted by the merchant entities, that helps the merchant entities across all industries in determining fraudulent payment transactions and separating received online transaction orders into a non-fraudulent transaction category, a fraudulent transaction category, and a suspicious transaction category.

The collaborative database also stores a history of non-fraudulent orders to facilitate expeditious, efficient, and accurate processing of online payment orders so that the merchant entities can rely not only on their own data files of known fraudulent orders, but also on the combined data files of hundreds or thousands of merchant entities whose collective experience is vastly more accurate, beneficial, and useful in stopping fraud online and in their stores, thereby improving the shopping experience for legitimate consumers. Furthermore, the computer implemented method and system disclosed herein allows the merchant entities to timely share fraudulent order data files across all types of devices from which the fraudulent orders are submitted, so that a massive new stream of real time information can be tapped to potentially prevent half of the current fraud experienced by merchant entities.

The computer implemented method and system disclosed herein provides a collaborative fraud prevention platform comprising at least one processor configured to determine and prevent a fraudulent payment transaction. The computer implemented method and system also generates a collaborative database accessible by multiple reviewing entities via a network for determining the fraudulent payment transaction. As used herein, the term “reviewing entities” refers to entities that review a payment transaction performed by a consumer with a merchant entity for purchasing a product and/or a service from the merchant entity, for determining and preventing fraud associated with the payment transaction. The reviewing entities are, for example, merchant entities, retailers, a web service or an application programming interface (API) that conducts fraud analysis, other participants in the collaborative environment, etc. The collaborative database collaboratively and dynamically receives and stores transaction history data of multiple payment transactions from the reviewing entities. As used herein, the term “transaction history data” refers to data associated with past payment transactions performed for purchasing a product and/or a service from a merchant entity. The transaction history data comprises, for example, transaction information of the payment transactions such as a consumer name, a product name, address information, payment information, etc., characteristics of consumer accounts engaged in the payment transactions, etc. As used herein, the term “characteristics of the consumer account” refers to factors associated with the consumer account that facilitate determination of consumer behavior in a merchant market. The characteristics of the consumer account comprise, for example, information on online social activities of the consumer, online purchasing activities of the consumer, web activities of the consumer, financial reputation of the consumer in the merchant market, analytics corresponding to social behavior of the consumer in the merchant market, etc.

The collaborative database collaboratively and dynamically receives, stores, and updates account information of the reviewing entities and consumer accounts engaged in the payment transactions in real time to facilitate enhanced accessibility by the reviewing entities. The collaborative fraud prevention platform extracts data items from the received transaction history data of the payment transactions and stores the extracted data items into data fields for the generation of the collaborative database. The data fields categorize the received transaction history data into a transaction category during the generation of the collaborative database. The transaction category is, for example, a fraudulent transaction category, a non-fraudulent transaction category, and a suspicious transaction category.

In an embodiment, the collaborative fraud prevention platform generates a reliability rating for each of the reviewing entities based on multiple rating parameters associated with contributions of the transaction history data by each of the reviewing entities. As used herein, the term “rating parameters” refers to measurable factors configured to define reliability of a merchant entity based on contributions of the merchant entity to a specific financial scenario. The rating parameters comprise, for example, a volume of contributions, accuracy and quality of the contributed transaction history data, frequency of contributions by the merchant entity, etc. The reliability rating of each of the reviewing entities assists other reviewing entities to assess reliability of the transaction history data contributed by each of the reviewing entities in the determination of the fraudulent payment transaction.

In an embodiment, the collaborative fraud prevention platform further generates a white list of consumer accounts associated with non-fraudulent payment transactions based on inputs received from the reviewing entities. As used herein, the term “non-fraudulent payment transactions” refers to genuine and authentic financial transactions initiated by a consumer for purchasing a product and/or a service provided by a merchant entity. The generated white list facilitates expeditious processing of future non-fraudulent payment transactions associated with the consumer accounts. In an embodiment, the collaborative fraud prevention platform performs a real time analysis of account information of the reviewing entity, consumer account information, and/or the transaction history data of the payment transactions stored in the collaborative database for estimating multiple retail trends for dynamically updating, for example, one or more of fraud determination and prevention models, affiliated strategies, operations, staffing employed by a reviewing entity, etc. As used herein, the term “retail trends” refers to market trends that indicate growth and performance of a merchandised product and/or a service introduced in a merchant market. The retail trends enable a merchant entity to identify and develop marketing strategies that can be used to improve the growth and the performance of the merchandised product and/or the service in the merchant market. The retail trends comprise, for example, consumer purchasing trends, a demand for a product or a service, a fall in the demand for a product or a service when price of the product or the service is increased, etc.

Consider a scenario where a merchant entity transmits a transaction request received from a consumer account to a payment gateway via the network for verifying the transaction request. On successful verification of the transaction request, the payment gateway transmits an approved message to the merchant entity. The merchant entity may then wish to determine the authenticity of the transaction request. The merchant entity itself or another reviewing entity transmits a fraud determination query to the collaborative fraud prevention platform, for example, via a network. The collaborative fraud prevention platform receives the fraud determination query associated with the transaction request associated with the consumer account from the reviewing entity via the network for determining authenticity or non-authenticity of the transaction request. The collaborative fraud prevention platform performs a search in the collaborative database based on the received fraud determination query by comparing current transaction data from the transaction request with the transaction history data stored in the collaborative database. The collaborative fraud prevention platform also performs an analysis of the characteristics of the consumer account obtained from the stored transaction history data.

The collaborative fraud prevention platform dynamically generates a fraud determination report based on the comparison of the current transaction data from the transaction request with the stored transaction history data, and the analysis of the characteristics of the consumer account. The fraud determination report indicates the authenticity or the non-authenticity of the transaction request for configurable periods of time, for example, 1 to 2 weeks, 3 to 5 weeks, etc., to enable the reviewing entity to determine the fraudulent payment transaction, and complete processing of the transaction request or discontinue the processing of the transaction request. In an embodiment, the fraud determination report indicates the non-authenticity of the transaction request on immediate detection of the current transaction data associated with the stored transaction history data of a past fraudulent payment transaction, instructing the reviewing entity to discontinue the processing of the transaction request. In another embodiment, the fraud determination report indicates the authenticity of the transaction request for a first period of time, for example, for the first 1 to 2 weeks, instructing the reviewing entity to continue the processing of the transaction request. In this embodiment, the collaborative fraud prevention platform generates another fraud determination report that indicates the authenticity or the non-authenticity of the transaction request on non-detection or detection of the current transaction data associated with the stored transaction history data of a past fraudulent payment transaction respectively, for a second period of time, for example, for the next 3 to 5 weeks, instructing the reviewing entity to complete the processing of the transaction request or discontinue the processing of the transaction request respectively. That is, the fraud determination report indicates the authenticity of the transaction request on non-detection of the current transaction data associated with the stored transaction history data of a past fraudulent payment transaction for the second period of time, instructing the reviewing entity to complete the processing of the transaction request. Further, the fraud determination report indicates the non-authenticity of the transaction request on detection of the current transaction data associated with the stored transaction history data of a past fraudulent payment transaction for the second period of time, instructing the reviewing entity to discontinue the processing of the transaction request. In an embodiment, the collaborative fraud prevention platform receives one or more fraud related parameters from the reviewing entity for configuring attributes of the fraud determination report for display on a graphical user interface. As used herein, the term “attributes” refers to display features of a fraud determination report that can be adjusted to create custom automated fraud detection screens.

In an embodiment, the collaborative fraud prevention platform generates and transmits notifications to the reviewing entities for performing multiple actions associated with one or more of the collaborative reception and the storage of the transaction history data of the payment transactions received from the reviewing entities, the determination of the fraudulent payment transaction, completion or discontinuation of the processing of the transaction request, etc.

By pooling transaction history data on fraudulent transaction orders in real time in the collaborative database to create a live feedback loop, and then comparing their own orders as they are processed against the data pool in the collaborative database, merchant entities can reduce their fraudulent order rates substantially by identifying and preventing active fraudsters, controlling thousands of hijacked servers responsible for processing online transaction payments, etc., thereby resulting in savings that can reach billions of dollars per year. The computer implemented method and system disclosed herein implements a fail-safe version of fraud prevention systems, for example, after the implementation of existing fraud prevention systems in a payment transaction processing workflow in order to detect fraudsters that have learned to evade the other fraud prevention systems.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for determining a fraudulent payment transaction in a collaborative environment.

FIG. 2 exemplarily illustrates a process flow diagram comprising the steps for collaboratively receiving and storing transaction history data of multiple payment transactions from multiple reviewing entities.

FIG. 3 exemplarily illustrates a process flow diagram comprising the steps performed by a collaborative fraud prevention platform for receiving a fraud determination query associated with a transaction request from a reviewing entity and performing a search in the collaborative database based on the received fraud determination query.

FIG. 4 exemplarily illustrates a flow diagram comprising the steps performed by the collaborative fraud prevention platform for determining a fraudulent payment transaction in a collaborative environment.

FIG. 5 exemplarily illustrates interactions performed between merchant entities, a payment gateway, and a collaborative database for determining and preventing a fraudulent payment transaction in a collaborative environment.

FIG. 6 exemplarily illustrates a tabular representation showing prevention of a fraudulent payment transaction in a collaborative environment by the collaborative fraud prevention platform.

FIG. 7 exemplarily illustrates a schema of the collaborative database comprising multiple tables for storing transaction history data of multiple payment transactions received from multiple reviewing entities.

FIG. 8 exemplarily illustrates a computer implemented system for determining a fraudulent payment transaction in a collaborative environment.

FIG. 9 exemplarily illustrates the architecture of a computer system employed by the collaborative fraud prevention platform for determining a fraudulent payment transaction in a collaborative environment.

### DETAILED DESCRIPTION OF THE INVENTION

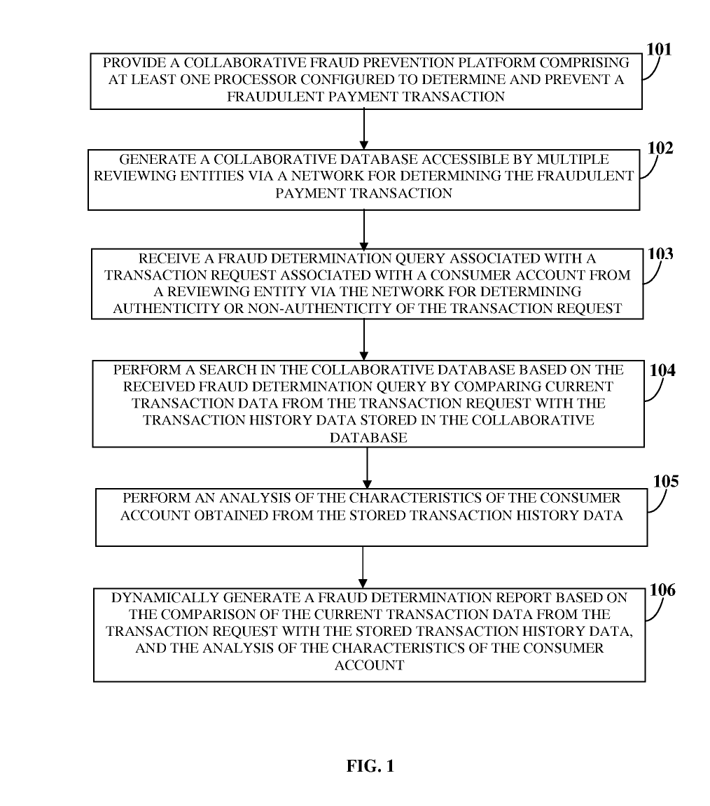

FIG. 1 illustrates a computer implemented method for determining a fraudulent payment transaction in a collaborative environment. As used herein, the term “fraudulent payment transaction” refers to a financial transaction initiated by a fraudulent entity, herein referred to as a “fraudster” in disguise of a consumer for fraudulently purchasing a product and/or a service provided by a merchant entity. Also, as used herein, the term “collaborative environment” refers to an environment in which multiple merchant entities crowd source their data banks of transaction history data corresponding to purchases of products and/or services by consumers from the merchant entities to facilitate fraud determination and prevention. The computer implemented method disclosed herein provides 101 a collaborative fraud prevention platform comprising at least one processor configured to determine and prevent the fraudulent payment transaction. The collaborative fraud prevention platform determines and prevents fraudulent payment transactions in a merchant market by fraudsters in disguise of consumers purchasing a product and/or a service merchandised by a merchant or a retailer. The collaborative fraud prevention platform reduces online payment fraud by pooling and sharing merchant order data. The collaborative fraud prevention platform enables multiple merchant entities to combine their fraudulent and suspicious order files into a collective data pool for use by all merchant entities for preventing future payment fraud. In an embodiment, the collaborative fraud prevention platform is configured as a platform as a service (PaaS) or as a software as a service (SaaS). In another embodiment, the collaborative fraud prevention platform is implemented as a website or a web based platform hosted on a server or a network of servers.

The collaborative fraud prevention platform is accessible to multiple reviewing entities via a network, for example, through a broad spectrum of technologies and devices such as personal computers with access to the internet, internet enabled cellular phones, tablet computing devices, etc. As used herein, the term “reviewing entities” refers to entities that review a payment transaction performed by a consumer with a merchant entity for purchasing a product and/or a service from the merchant entity, for determining and preventing fraud associated with the payment transaction. The reviewing entities are, for example, merchant entities, retailers, a web service or an application programming interface (API) that conducts fraud analysis, other participants in the collaborative environment, etc. The network used by the reviewing entities to access the collaborative fraud prevention platform is, for example, the internet, an intranet, a wireless network, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long term evolution (LTE) mobile communication network, a public telephone network, etc., a local area network, a wide area network, an internet connection network, an infrared communication network, etc., or a network formed from any combination of these networks.

In an embodiment, the collaborative fraud prevention platform is implemented in a cloud computing environment. As used herein, the term “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. In this embodiment, the collaborative fraud prevention platform is a cloud computing based platform implemented as a service for determining the fraudulent payment transaction in the collaborative environment. In an embodiment, the collaborative fraud prevention platform is developed, for example, using the Google App engine cloud infrastructure of Google Inc.

The reviewing entities access the collaborative fraud prevention platform via the network using computing devices. The computing devices comprise, for example, personal computers, tablet computing devices, mobile computers, mobile phones, smart phones, portable computing devices, laptops, personal digital assistants, touch centric devices, workstations, client devices, portable electronic devices, network enabled computing devices, interactive network enabled communication devices, web browsers, any other suitable computing equipment, and combinations of multiple pieces of computing equipment, etc. The computing device may also be a hybrid device that combines the functionality of multiple devices. Examples of a hybrid computing device comprise a cellular telephone that includes gaming and electronic mail (email) functions, and a portable device that receives email, supports mobile telephone calls, and supports web browsing. Computing equipment may be used to implement applications such as a web browser, an email application, etc. Computing equipment, for example, one or more servers may be associated with one or more online services.

The computer implemented method disclosed herein generates 102 a collaborative database accessible by multiple reviewing entities via a network for determining the fraudulent payment transaction. The collaborative database collaboratively and dynamically receives and stores transaction history data of multiple payment transactions from the reviewing entities. As used herein, the term “transaction history data” refers to data associated with past payment transactions performed for purchasing a product and/or a service from a merchant entity. The transaction history data comprises, for example, transaction information of the payment transactions such as a consumer name, a product name, address information, payment information, etc., characteristics of consumer accounts engaged in the payment transactions, etc. As used herein, the term “characteristics of the consumer account” refers to factors associated with the consumer account that facilitate determination of consumer behavior in a merchant market. The characteristics of the consumer account comprise, for example, information on online social activities of the consumer, online purchasing activities of the consumer, web activities of the consumer, financial reputation of the consumer in the merchant market, analytics corresponding to social behavior of the consumer in the merchant market, etc.

In an embodiment, the collaborative database collaboratively and dynamically receives, stores, and updates account information of the reviewing entities and the consumer accounts engaged in the payment transactions in real time to facilitate enhanced accessibility by the reviewing entities. The collaborative fraud prevention platform extracts data items from the received transaction history data of the payment transactions and stores the extracted data items into data fields for generating the collaborative database. The data fields categorize the received transaction history data into a transaction category during the generation of the collaborative database. The transaction category is, for example, a fraudulent transaction category, a non-fraudulent transaction category, and a suspicious transaction category. The reviewing entities can compare their ongoing payment transaction request or order data with the transaction history data stored in the collaborative database via the collaborative fraud prevention platform to better identify fraudulent payment transactions and suspicious payment transactions, and expedite the processing of non-fraudulent payment transactions that otherwise may have been held for manual review by the reviewing entities. As used herein, the term “non-fraudulent payment transactions” refers to genuine and authentic financial transactions initiated by a consumer for purchasing a product and/or a service provided by a merchant entity.

In an embodiment, the collaborative database is implemented on the collaborative fraud prevention platform. In another embodiment, the collaborative database is operably connected to the collaborative fraud prevention platform via the network. In an embodiment, the collaborative database is any storage area or medium that can be used for storing data and files. In another embodiment, the collaborative database is, for example, a structured query language (SQL) data store or a not only SQL (NoSQL) data store such as the Microsoft® SQL Server®, the Oracle® servers, the MySQL® database of MySQL AB Company, the mongoDB® of 10gen, Inc., the Neo4j graph database, the Cassandra database of the Apache Software Foundation, the HBase™ database of the Apache Software Foundation, etc. In an embodiment, the collaborative database can also be a location on a file system. In another embodiment, the collaborative database can be remotely accessed by the collaborative fraud prevention platform via the network. In another embodiment, the collaborative database is configured as a cloud based database implemented in a cloud computing environment, where computing resources are delivered as a service over the network, for example, the internet.

In an embodiment, the collaborative database is housed in, and connected to the network via a database server. The database server is a processing system that maintains various databases that are accessible by the reviewing entities and the collaborative fraud prevention platform via the network. The collaborative database is a primary repository for all of the transaction history data submitted by the reviewing entities related to fraudulent payment transactions, consumer accounts associated with the fraudulent payment transactions, and accounts of the reviewing entities. Furthermore, the collaborative fraud prevention platform allows the reviewing entities to search, query, and retrieve transaction history data that is stored in the collaborative database. The collaborative database is configured as a custom database that is designed and incorporated into the collaborative fraud prevention platform.

In an embodiment, the collaborative fraud prevention platform generates a reliability rating, also referred to as a “collaboration index”, for each of the reviewing entities based on multiple rating parameters associated with contributions of the transaction history data by each of the reviewing entities. As used herein, the term “rating parameters” refers to measurable factors configured to define reliability of a merchant entity based on contributions of the merchant entity to a specific financial scenario. The rating parameters comprise, for example, a volume of contributions, accuracy and quality of the contributed transaction history data, frequency of contributions by the merchant entity, etc. The reliability rating of each of the reviewing entities assist other reviewing entities to assess reliability of the transaction history data contributed by each of the reviewing entities in the determination of the fraudulent payment transaction. For example, the transaction history data contributed by high rated reviewing entities can be more heavily relied upon when screening for suspicious activity.

Consider a scenario where a merchant entity transmits a transaction request received from a consumer account to a payment gateway via the network for verifying the transaction request. As used herein, the term “payment gateway” refers to a payment processing service that verifies authenticity of a consumer's credit account associated with a transaction request and processes the transaction request. The payment gateway is, for example, an acquiring bank, a credit card processor, acquiring bank and credit card associations, etc. On successful verification of the transaction request, the payment gateway verifies and approves the transaction request and transmits an approved message to the merchant entity, via the network. The merchant entity may then wish to determine the authenticity of the transaction request. The merchant entity itself or another reviewing entity transmits a fraud determination query to the collaborative fraud prevention platform, for example, via a network. The collaborative fraud prevention platform receives 103 a fraud determination query associated with the transaction request associated with the consumer account from the reviewing entity via the network for determining authenticity or non-authenticity of the transaction request. In an embodiment, the reviewing entity transmits a fraud determination query in the form of search terms. In another embodiment, a third party web service for the reviewing entity transmits the fraud determination query in the form of records of the transaction history data associated with the transaction request.

The collaborative fraud prevention platform performs 104 a search in the collaborative database based on the received fraud determination query by comparing current transaction data from the transaction request with the transaction history data stored in the collaborative database. The collaborative fraud prevention platform also performs 105 an analysis of the characteristics of the consumer account obtained from the stored transaction history data. Consider an example where a reviewing entity, for example, a merchant entity, wishes to search for any transaction history data associated with a payment transaction received by the reviewing entity from a consumer account via the collaborative fraud prevention platform to determine whether the received payment transaction is a fraudulent payment transaction or a non-fraudulent payment transaction. The collaborative fraud prevention platform determines the fraud payment transaction, for example, by performing an analysis of multiple characteristics of the consumer account, for example, online social activities of the consumer, financial reputation of the consumer in the merchant market, analytics corresponding to the social behavior of the consumer in the merchant market, etc., associated with the payment transaction request received from the consumer account. In an embodiment, the collaborative fraud prevention platform implements an authentication algorithm for determining the fraudulent payment transactions that are based on the characteristics of the consumer account predetermined by the collaborative fraud prevention platform, rather than the typical characteristics of the consumer account, for example, a shipping address, an internet protocol (IP) address of the consumer account, an identification code of a consumer device, other typical metrics, etc. In an embodiment, the collaborative fraud prevention platform implements self-learning fraud prevention algorithms that periodically evolve with new techniques and patterns used by fraudsters to evade the traditional fraud detection systems as and when they emerge.

The collaborative fraud prevention platform dynamically generates 106 a fraud determination report based on the comparison of the current transaction data from the transaction request with the stored transaction history data, and the analysis of the characteristics of the consumer account. In an embodiment, the fraud determination report is generated by a reviewing entity, for example, a consumer service representative, a fraud manager, etc., via the collaborative fraud prevention platform by manually reviewing and analyzing the current transaction data from the transaction request. The generated fraud determination reports stored in the collaborative database and accessible by the reviewing entities prevent the need for duplicating investigative measures for determination of fraudulent payment transactions by the reviewing entities. The fraud determination report indicates the authenticity or the non-authenticity of the transaction request for configurable periods of time to enable the reviewing entity to determine the fraudulent payment transaction, and to complete processing of the transaction request or discontinue the processing of the transaction request. As used herein, the term “configurable period of time” refers to a period of time that is configured, for example, by the collaborative fraud prevention platform, the reviewing entity, etc., to determine a fraudulent payment transaction.

In an embodiment, the fraud determination report indicates the non-authenticity of the transaction request on immediate detection of the current transaction data associated with the stored transaction history data of a past fraudulent payment transaction, thereby instructing the reviewing entity to discontinue the processing of the transaction request. For example, the collaborative fraud prevention platform determines the transaction history data of a fraudulent payment transaction associated with a consumer account that submitted the transaction request to the reviewing entity as soon as the collaborative fraud prevention platform receives the fraud determination query from the reviewing entity. The collaborative fraud prevention platform immediately transmits the fraud determination report to the reviewing entity, thereby preventing completion of processing of the fraudulent payment transaction requested by the fraudster.

In another embodiment, the fraud determination report indicates the authenticity of the transaction request for a first period of time among the configurable periods of time on non-detection of the current transaction data associated with the stored transaction history data of a past fraudulent payment transaction, thereby instructing the reviewing entity to continue the processing of the transaction request. In another embodiment, the fraud determination report indicates the authenticity or the non-authenticity of the transaction request on non-detection or detection of the current transaction data associated with the stored transaction history data of a past fraudulent payment transaction respectively, for a second period of time among the configurable periods of time, thereby instructing the reviewing entity to complete the processing of the transaction request or discontinue the processing of the transaction request respectively. That is, the fraud determination report indicates the authenticity of the transaction request on non-detection of the current transaction data associated with the stored transaction history data of a past fraudulent payment transaction for the second period of time, instructing the reviewing entity to complete the processing of the transaction request. Further, the fraud determination report indicates the non-authenticity of the transaction request on detection of the current transaction data associated with the stored transaction history data of a past fraudulent payment transaction for the second period of time, instructing the reviewing entity to discontinue the processing of the transaction request.

Consider an example where a fraudster places a fraudulent transaction request for purchasing a product from reviewing merchant entity via a merchant portal over a transaction period of 5 weeks. The fraudster places a fraudulent payment transaction order for a product merchandised by the merchant entity to be shipped to the fraudster at the rate of 10 fraudulent payment transaction orders every week of a 5 week transaction period. As used herein, the term “transaction period” refers to a period of time determined for shipment of a purchased product from a merchant entity to a consumer. The merchant entity receives the fraudulent transaction request from the consumer account and believes the received transaction request to be non-fraudulent. However, the merchant entity itself or via another reviewing entity wishes to confirm authenticity of the received transaction request and therefore, uses the collaborative fraud prevention platform to verify the authenticity of the received transaction request before proceeding with processing of the received transaction request. The reviewing entity subscribes to and logs in to the collaborative fraud prevention platform using a computing device. The reviewing entity searches for the transaction history data of any fraudulent payment transaction in the collaborative database to determine any fraud associated with the transaction request. The collaborative fraud prevention platform generates and transmits a display notification comprising instructions to the reviewing entity via the GUI of the collaborative fraud prevention platform on how to search in the collaborative database. In an embodiment, the collaborative fraud prevention platform awaits instructions from the reviewing entity account for querying the collaborative database for searching for the transaction history data of the fraudulent payment transaction, if the reviewing entity is represented by a third party web service. The collaborative fraud prevention platform determines the fraudulent payment transaction after the first period of time once the transaction history data associated with the fraudulent payment transaction is uploaded in the collaborative database by another reviewing entity. In this example, the collaborative fraud prevention platform may first determine that the transaction request is non-fraudulent by performing the search in the collaborative database and transmit the fraud determination report to the reviewing entity to complete processing of the transaction request. The reviewing entity completes the processing of the transaction request for the first two weeks of the transaction period for shipment of the transaction request. In the meantime, another reviewing entity uploads the transaction history data of the fraudulent payment transaction associated with the consumer account of the transaction request. The collaborative fraud prevention platform transmits the fraud determination report to the reviewing entity instructing the reviewing entity to discontinue the processing of the transaction request. The reviewing entity terminates the shipment of the transaction request for the remaining period of the transaction period for the shipment of the transaction request, for example, for the remaining 3 weeks. The collaborative fraud prevention platform therefore reduces direct losses incurred by a merchant entity or the reviewing entity from fraud from shipment of, for example, 50 fraudulent payment transaction orders over the 5 week transaction period to the shipment of 20 fraudulent payment transaction orders, thereby resulting in a total reduction in losses incurred by the merchant entity or the reviewing entity to 60%. In the absence of the collaborative fraud prevention platform comprising the collaborative database, the reviewing entity would have processed shipment of all 50 fraudulent payment transaction orders, thereby incurring a 100% loss.

In an embodiment, the collaborative fraud prevention platform displays the fraud determination report in a customized format which has been modified by the reviewing entity in advance to enable usage of the fraud determination report as a customized fraud detection screen capable of interfacing with the reviewing entity's other order processing systems. The collaborative fraud prevention platform receives one or more fraud related parameters from the reviewing entity for configuring attributes of the fraud determination report for display on the GUI of the collaborative fraud prevention platform. As used herein, the term “fraud related parameters” refers to a set of parameters configured by a merchant entity or a reviewing entity to customize display of an output of the collaborative fraud prevention platform configured for determining and preventing fraudulent payment transactions by consumers in a merchant market. Also, as used herein, the term “attributes” refers to display features of a fraud determination report that can be adjusted to create custom automated fraud detection screens. The fraud related parameters constitute a customized rule set that enables the reviewing entity to adjust the attributes of the fraud determination report to create custom automated fraud detection screens. In an embodiment, the collaborative fraud prevention platform periodically aggregates and publishes data, and displays an aggregated statistical analysis report of the fraud determination and prevention activity performed by the collaborative database to the reviewing entity. The aggregated statistical analysis report assists the reviewing entities to gauge the benefits of their contributions to the collaborative fraud prevention platform for the determination and the prevention of the fraudulent payment transactions.

In an embodiment, the collaborative fraud prevention platform generates a white list of consumer accounts associated with non-fraudulent payment transactions based on inputs received from the reviewing entities via the GUI of the collaborative fraud prevention platform. The generated white list facilitates expeditious processing of future non-fraudulent payment transactions associated with the consumer accounts listed in the white list, thereby preventing delay in completing processing of the non-fraudulent payment transactions which would have been held for manual review by the reviewing entities.

In an embodiment, the collaborative fraud prevention platform periodically generates and transmits notifications to the reviewing entities for performing multiple actions and for keeping the reviewing entities apprised of events occurring in the collaborative fraud prevention platform. The actions performed by the collaborative fraud prevention platform are associated with, for example, one or more of the collaborative reception and the storage of the transaction history data of the payment transactions received from the reviewing entities, the determination of the fraudulent payment transaction, the completion or the discontinuation of the processing of the transaction request, etc. In an embodiment, the collaborative fraud prevention platform transmits the notifications to the computing device of the reviewing entity, for example, via electronic mail (email), a short message service (SMS) message, a multimedia messaging service (MMS) message, etc.

Consider an example where a reviewing entity, for example, a merchant entity wishes to upload transaction history data associated with one or more fraudulent payment transactions encountered by the reviewing entity in the merchant market. The collaborative fraud prevention platform receives an access authorization request from a reviewing entity that requests access to the collaborative fraud prevention platform via the network. The collaborative fraud prevention platform determines whether the reviewing entity is a new user or an existing user of the collaborative fraud prevention platform. In an embodiment, the reviewing entity directly inputs and transmits the access authorization request to the collaborative fraud prevention platform via a graphical user interface (GUI) of the collaborative fraud prevention platform using a computing device. In another embodiment, the automated access authorization request is transmitted by a third party web service for requesting access to the collaborative fraud prevention platform for the reviewing entity. If the collaborative fraud prevention platform determines that the reviewing entity is a new user, the reviewing entity is prompted for additional login information by the collaborative fraud prevention platform to create an account for the reviewing entity. In an embodiment, the additional login information provided by the reviewing entity is manually reviewed by an administrative entity of the collaborative fraud prevention platform or verified via a secure electronic mail (email) by the collaborative fraud prevention platform. In another embodiment, the additional login information provided by the reviewing entity is automatically reviewed by an authorization algorithm implemented by the collaborative fraud prevention platform. The collaborative fraud prevention platform approves or rejects the reviewing entity requesting access to the collaborative fraud prevention platform based on the review conducted by the collaborative fraud prevention platform. The collaborative fraud prevention platform transmits a notification to the reviewing entity indicating the decision taken by the collaborative fraud prevention platform in response to the access authorization request transmitted by the reviewing entity.

If the collaborative fraud prevention platform determines that the reviewing entity is an existing user, the collaborative fraud prevention platform verifies the reviewing entity account by retrieving the reviewing entity account information stored in the collaborative database. The collaborative fraud prevention platform grants access to the existing reviewing entity account after confirming that the retrieved reviewing entity account is authorized to access the collaborative fraud prevention platform. In an embodiment, the collaborative fraud prevention platform verifies the reviewing entity account by multiple verification means, for example, a password comparison, other comparable means, etc. The collaborative fraud prevention platform transmits an access denied notification to the reviewing entity account on determining that the reviewing entity account is not authorized to access the collaborative fraud prevention platform. In an embodiment, the collaborative fraud prevention platform transmits the access denied notification to the reviewing entity account via the network. In another embodiment, the collaborative fraud prevention platform displays the access denied notification on the GUI of the collaborative fraud prevention platform that is accessed by the reviewing entity account using the computing device.

After successful authentication of the reviewing entity account to the collaborative fraud prevention platform, the collaborative fraud prevention platform generates a display notification of instructions on the GUI on how to upload transaction history data associated with transaction requests received and processed by the reviewing entity to the collaborative database. In an embodiment, the collaborative fraud prevention platform awaits instructions from the reviewing entity account for uploading the transaction history data to the collaborative database, if the reviewing entity is represented by a third party web service. In an embodiment, the reviewing entity selects and submits the transaction history data to the collaborative fraud prevention platform for uploading the selected transaction history data on the collaborative database. In an embodiment, the reviewing entity can upload a single record or a single data file associated with the transaction requests received and processed by the reviewing entity via a form. In another embodiment, the reviewing entity can upload multiple data files. In an embodiment, the reviewing entity uploads the transaction history data in multiple formats of data files, for example, a comma-separated value (CSV) data file format, an extensible markup language (XML) data file format, etc., and any combination thereof.

The collaborative fraud prevention platform verifies the format of the uploaded transaction history data. If the collaborative fraud prevention platform detects that the format of the uploaded transaction history data is not according to the specifications determined by the collaborative database, then the collaborative fraud prevention platform ceases the upload of the transaction history data received from the reviewing entities. The collaborative fraud prevention platform transmits a notification to the reviewing entity with information on formatting violations and means to clean and re-submit the transaction history data. On successful reception of the uploaded transaction history data in the collaborative database, the collaborative fraud prevention platform transmits a notification to the reviewing entity account indicating the successful reception. The collaborative fraud prevention platform parses the uploaded transaction history data into relevant tables and data fields in the tables in the collaborative database as per an algorithm implemented by the collaborative database. The data fields are defined, for example, by file headers. The reviewing entities can then access the transaction history data stored in the collaborative database after logging in to the collaborative fraud prevention platform via a secure connection. The reviewing entities that are logged into their accounts via a secure connection can avail themselves of the collaborative fraud prevention platform's output by accessing the data, for example, via single searches on the collaborative fraud prevention platform, via a web service and/or an application programming interface (API), which enables queries from other systems, or via other means as required or requested by the reviewing entities.

In an embodiment, the collaborative fraud prevention platform performs a real time analysis of, for example, account information of the reviewing entity, consumer account information, and/or the transaction history data of the payment transactions stored in the collaborative database for estimating multiple retail trends. As used herein, the term “retail trends” refers to market trends that indicate growth and performance of a merchandised product and/or a service introduced in a merchant market. The retail trends enable a merchant entity to identify and develop marketing strategies that can be used to improve the growth and the performance of the merchandised product and/or the service in the merchant market. The retail trends comprise, for example, consumer purchasing trends, a demand for a product or a service, a fall in the demand for a product or a service when price of the product or the service is increased, etc. The retails trends facilitate dynamic updating of, for example, one or more fraud determination and prevention models, affiliated strategies, operations, staffing employed by the reviewing entity, etc. In an embodiment, the collaborative database can be used by the reviewing entities for improving and growing operational activities of the reviewing entities' organization as well as operations of all organizations affiliated with the retail industry, for example, suppliers of raw materials, a manufacturing industry, a distribution industry, professional services, other services, other affiliated organizations, etc. Collaborative data on payment transactions can be used to produce real time or live information on a variety of broad retail trends to help reviewing entities and affiliated organizations to create and/or adjust strategies, operations, and staffing more quickly and efficiently than they otherwise would have if the reviewing entities and affiliated organizations are forced to wait for data to be collected, interpreted, and distributed, for example, by trade magazines and other traditional media sources. The collaborative data from the reviewing entities can also serve as an accurate measure of the impacts of macroeconomic shocks and events on the merchant industry. Using the computer implemented method and system disclosed herein, the reviewing entities and the affiliated organizations can identify retail trends within product sectors, shifts in consumer behavior and purchasing trends, and changes in other more microeconomic factors, and adjust accordingly their retail and manufacturing operations. This collaborative data can also serve as a more accurate and timely predictor of the success of new product launches, new payment methods, and any other technologies used within the merchant industry.

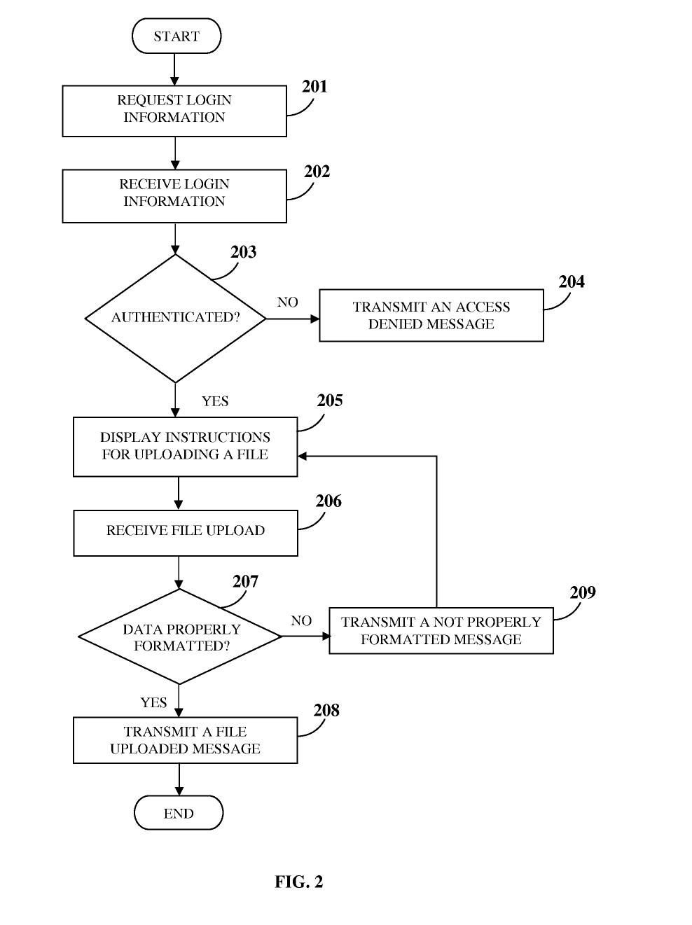

FIG. 2 exemplarily illustrates a process flow diagram comprising the steps for collaboratively receiving and storing transaction history data of multiple payment transactions from multiple reviewing entities. FIG. 2 exemplarily illustrates how the reviewing entities can upload the transaction history data associated with the payment transaction requests received from the consumers at the time of and/or subsequent to completion of processing of the payment transaction requests by the reviewing entities to the collaborative database. In an embodiment, the received transaction history data comprises, for example, data of fraudulent payment transactions, non-fraudulent payment transactions, and suspicious payment transactions. The collaborative fraud prevention platform transmits a notification requesting 201 login information to a reviewing entity account attempting to access the collaborative fraud prevention platform. In an embodiment, the collaborative fraud prevention platform displays the notification on the GUI of the collaborative fraud prevention platform to the reviewing entity. The collaborative fraud prevention platform receives 202 an access authorization request from the reviewing entity comprising the login information of the reviewing entity. The collaborative fraud prevention platform retrieves account information of the reviewing entity from the collaborative database and authenticates 203 the reviewing entity to grant access to the collaborative database. If the collaborative fraud prevention platform determines that the reviewing entity is not authorized to access the collaborative database, the collaborative fraud prevention platform generates and transmits 204 an “access denied” message to the reviewing entity. In an embodiment, the access denied message is transmitted and displayed to the reviewing entity directly via the GUI of the collaborative fraud prevention platform. In another embodiment, the access denied message is transmitted and displayed to the reviewing entity via a third party web service.

If the collaborative fraud prevention platform determines that the reviewing entity is authorized to access the collaborative database, the collaborative fraud prevention platform transmits an “access granted” message to the reviewing entity, thereby allowing the reviewing entity to access the collaborative database. The collaborative fraud prevention platform displays 205 instructions for uploading files containing the transaction history data associated with payment transactions received and processed by the reviewing entity. The reviewing entity selects and uploads desired transaction history data associated with the payment transactions to the collaborative database. The collaborative fraud prevention platform receives 206 the uploaded transaction history data from the reviewing entity. The collaborative fraud prevention platform then verifies and validates 207 formats of the uploaded transaction history data on the collaborative database. The collaborative fraud prevention platform ensures that the uploaded transaction history data and the information contained in the uploaded transaction history data are of an acceptable structure and format as allowed and supported by the collaborative database. If the uploaded transaction history data is properly formatted as per the instructions transmitted to the reviewing entity, the collaborative fraud prevention platform transmits 208 a “File uploaded” message to computing device of the reviewing entity. If the uploaded transaction history data is not properly formatted as per the instructions transmitted to the reviewing entity regarding upload of the transaction history data on the collaborative database, the collaborative fraud prevention platform transmits 209 a “not properly formatted” message to the computing device of the reviewing entity and again displays 205 instructions for uploading a file, thereby ensuring that the uploaded transaction history data is of the acceptable format. The reviewing entity can therefore successfully upload the transaction history data of past payment transactions comprising, for example, fraudulent payment transactions and non-fraudulent payment transactions to the collaborative database, facilitating other reviewing entities subscribed to the collaborative fraud prevention platform to access the collaborative database and determine and prevent fraud in their future payment transactions with consumers.

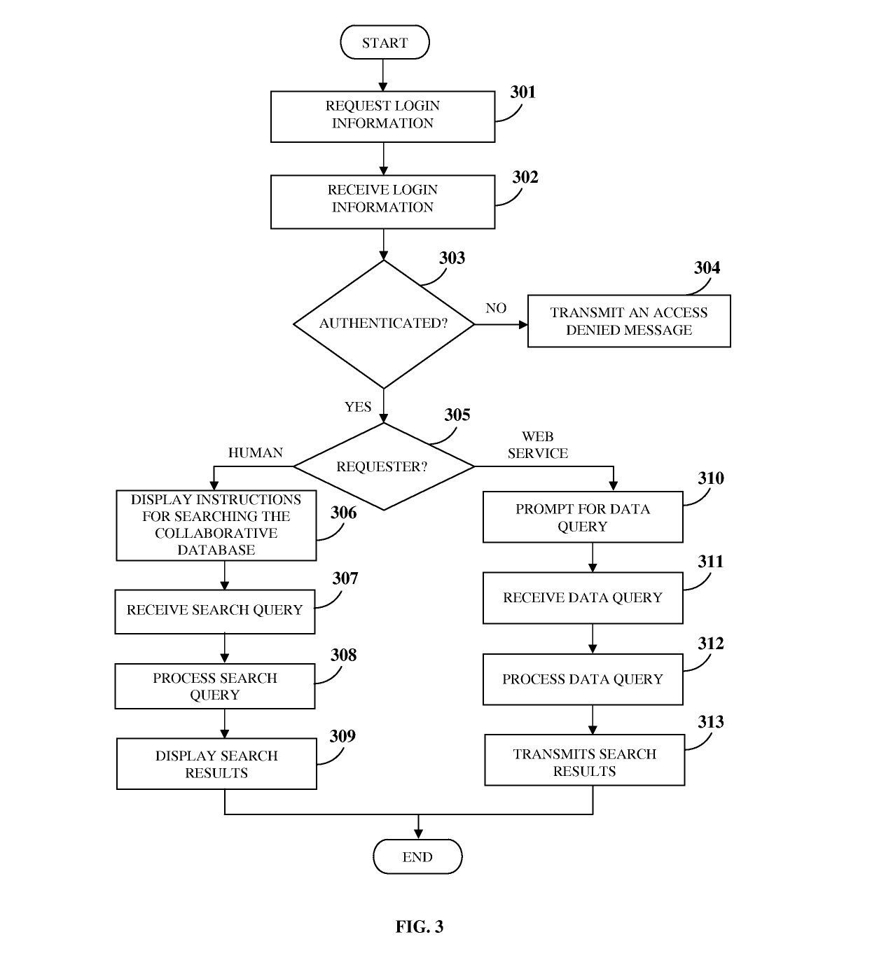

FIG. 3 exemplarily illustrates a process flow diagram comprising the steps performed by the collaborative fraud prevention platform for receiving a fraud determination query associated with a transaction request from a reviewing entity and performing a search in the collaborative database based on the received fraud determination query. FIG. 3 shows the steps for searching and/or querying of the transaction history data stored in the collaborative database by the reviewing entities. The collaborative fraud prevention platform transmits a notification requesting 301 login information to a reviewing entity account that requests access to the collaborative fraud prevention platform. The collaborative fraud prevention platform receives 302 an access authorization request from the reviewing entity comprising the login information of the reviewing entity. The collaborative fraud prevention platform authenticates 303 the reviewing entity. If the collaborative fraud prevention platform determines that the reviewing entity is not authorized to access the collaborative database, the collaborative fraud prevention platform generates and transmits 304 an “access denied” message to the reviewing entity.

If the collaborative fraud prevention platform determines that the reviewing entity is authorized to access the collaborative database, the collaborative fraud prevention platform transmits an “access granted” message to the reviewing entity, thereby allowing the reviewing entity to access the collaborative database. The collaborative fraud prevention platform then determines 305 whether the reviewing entity requesting a fraud determination report from the collaborative database is a human merchant entity or a third party web service. If the reviewing entity is a human merchant entity, the collaborative fraud prevention platform displays 306 instructions for searching the collaborative database. The collaborative fraud prevention platform then prompts the merchant entity to initiate searching and querying the collaborative database. The collaborative fraud prevention platform then receives 307 a search query or a fraud determination query for querying the collaborative database from the merchant entity. The collaborative fraud prevention platform processes 308 the search query and displays 309 the search results, for example, in the form of a fraud determination report to the merchant entity.

If the reviewing entity is a third party web service, the collaborative fraud prevention platform prompts 310 the third party web service for a data query or fraud determination query indicating that the collaborative fraud prevention platform is awaiting instructions from the third party web service to proceed with querying the collaborative database. The collaborative fraud prevention platform receives 311 the data query from the third party web service and processes 312 the received data query. The collaborative fraud prevention platform then transmits 313 the search results in the form of a fraud determination report to the third party web service. In an embodiment, the third party web service transmits the fraud determination report to the merchant entity via the network.

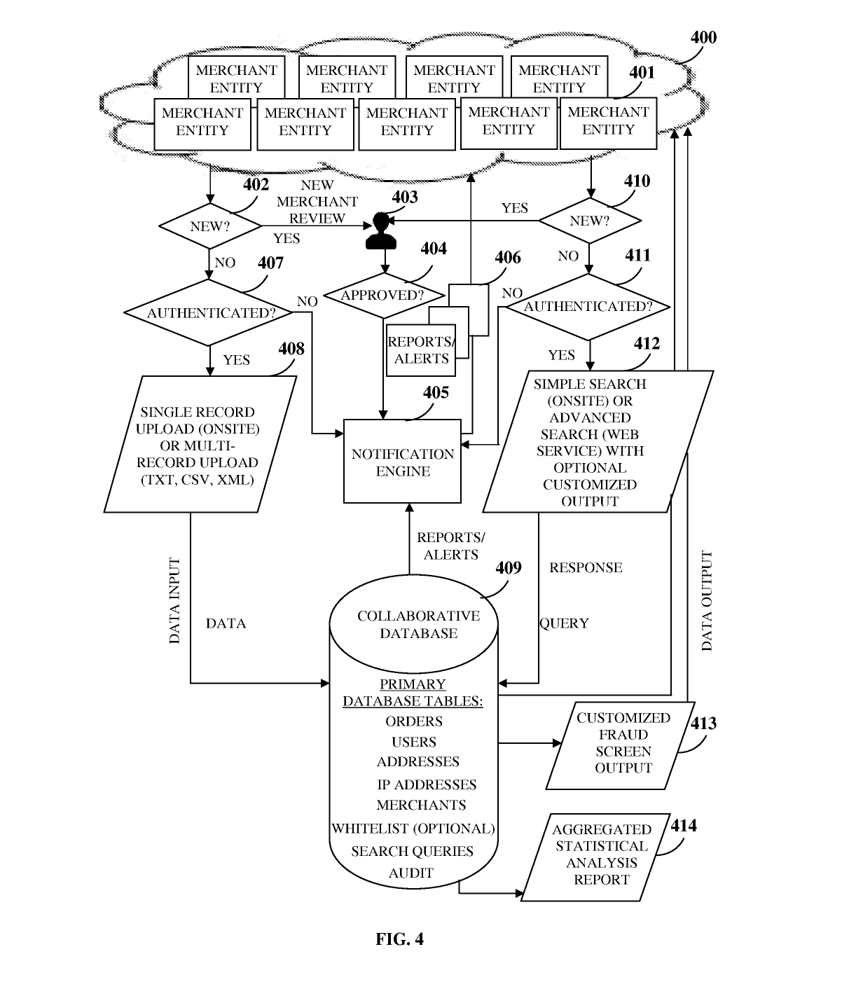

FIG. 4 exemplarily illustrates a flow diagram comprising the steps performed by the collaborative fraud prevention platform for determining a fraudulent payment transaction in a collaborative environment 400. An overview of the operation of the collaborative fraud prevention platform in the collaborative environment 400 is exemplarily illustrated in FIG. 4. In an embodiment, the reviewing entities, for example, merchant entities 401 or participants communicate with the collaborative fraud prevention platform via a network, for example, the internet, an intranet, a wireless network, a mobile communication network, etc. The collaborative fraud prevention platform receives login information from a merchant entity 401 via the network. The collaborative fraud prevention platform determines 402 whether the merchant entity 401 is a new user or an existing user as disclosed in the detailed description of FIG. 1. If the merchant entity 401 is a new user, an administrative entity 403 of the collaborative fraud prevention platform requests the merchant entity 401 for additional login information and reviews the additional login information provided by the merchant entity 401. The collaborative fraud prevention platform authenticates the merchant entity 401 and determines 404 whether to approve or reject the merchant entity 401. The collaborative fraud prevention platform transmits a notification 406, for example, a report, an alert, etc., indicating approval or rejection to the merchant entity 401 via a notification engine 405. If the merchant entity 401 is an existing user, the collaborative fraud prevention platform authenticates 407 the merchant entity 401. If the merchant entity 401 is authenticated, the collaborative fraud prevention platform allows the merchant entity 401 to upload the transaction history data to the collaborative database 409, for example, by uploading a single record onsite 408 or by performing a multi-record upload 408, for example, using a text file, a comma-separated value (CSV) data file, an extensible markup language (XML) data file, etc. If the merchant entity 401 is not authenticated, the collaborative fraud prevention platform transmits a notification 406, for example, a report, an alert, etc., indicating “access denied” to the merchant entity 401 via the notification engine 405.

Furthermore, FIG. 4 exemplarily illustrates the steps for performing a search in the collaborative database 409 based on a fraud determination query received from the merchant entity 401 via the network. The collaborative fraud prevention platform determines 410 whether the merchant entity 401 that requests access is a new user or an existing user as disclosed above and authenticates 411 the merchant entity 401. If the merchant entity 401 is authenticated, the collaborative fraud prevention platform allows the merchant entity 401 to perform a simple search 412 onsite or an advanced search 412 through a web service on the collaborative database 409 for determining any fraudulent payment transaction. The collaborative fraud prevention platform, in communication with the collaborative database 409, generates a customized fraud screen output 413 and an aggregated statistical analysis report 414. The collaborative fraud prevention platform displays the customized fraud screen output 413 and the aggregated statistical analysis report 414 to the merchant entities 401, for example, via the GUI of the collaborative fraud prevention platform and/or transmits the customized fraud screen output 413 to the computing device of each of the merchant entities 401.

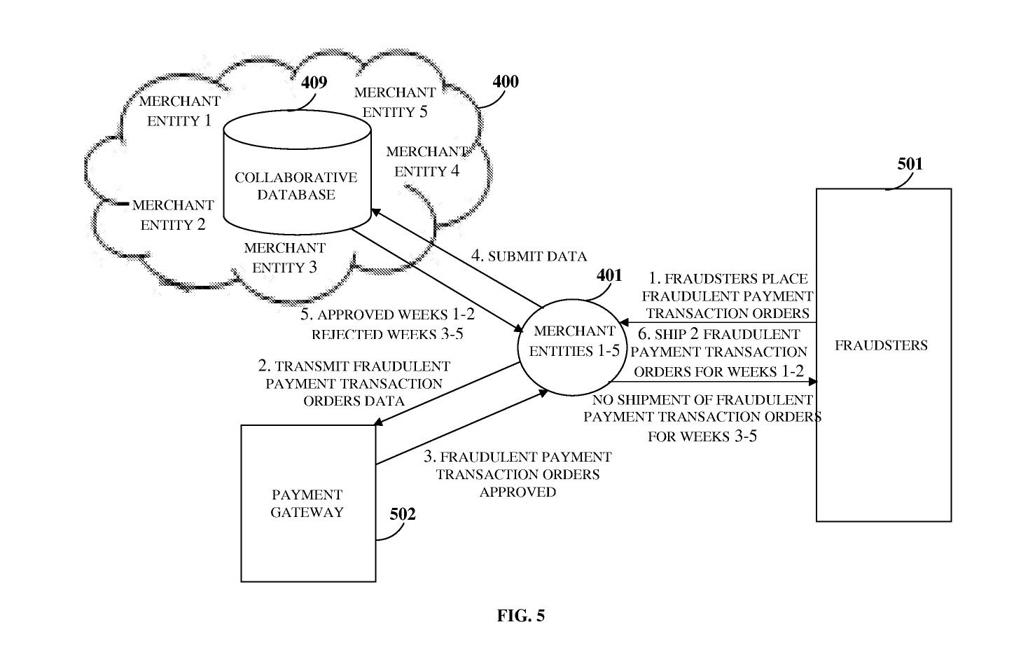

FIG. 5 exemplarily illustrates interactions performed between merchant entities 401, a payment gateway 502, and the collaborative database 409 for determining and preventing a fraudulent payment transaction in a collaborative environment 400. A fraudster 501 in disguise of a non-fraudulent consumer places fraudulent payment transaction orders to reviewing entities, for example, merchant entities 401, namely, merchant entity 1, merchant entity 2, merchant entity 3, merchant entity 4, merchant entity 5, etc., via the network. The merchant entities 401 transmit the fraudulent payment transaction order data to the payment gateway 502. The payment gateway 502 verifies the fraudulent payment transaction order data and sends an approval for completion of processing of the fraudulent payment transaction orders to the merchant entities 401 via the collaborative fraud prevention platform. The merchant entities 401 then submit data in the form of a fraud determination query to the collaborative database 409 via the collaborative fraud prevention platform. The collaborative fraud prevention platform, in communication with the collaborative database 409, transmits a fraud determination report to the merchant entities 401 in response to the fraud determination query indicating approval for the completion of the processing of the fraudulent payment transaction orders. In this example, the merchant entities 401 process the fraudulent payment transaction orders for the first 2 weeks of a transaction period of shipment for the fraudulent payment transaction orders. The collaborative database 409 may then receive updated transaction history data from one or more other merchant entities 401 in the third week of the transaction period of the shipment. The collaborative fraud prevention platform then determines that the ongoing payment transaction is fraudulent and notifies the merchant entities 401 of the fraudulent payment transaction via the notification engine 405 exemplarily illustrated in FIG. 4. On receiving the notification, the merchant entities 401 terminate the shipment of the fraudulent payment transaction orders in weeks 3-5, avoiding 60% of losses to be incurred due to the processing of the fraudulent payment transaction orders in the 5 week transaction period.

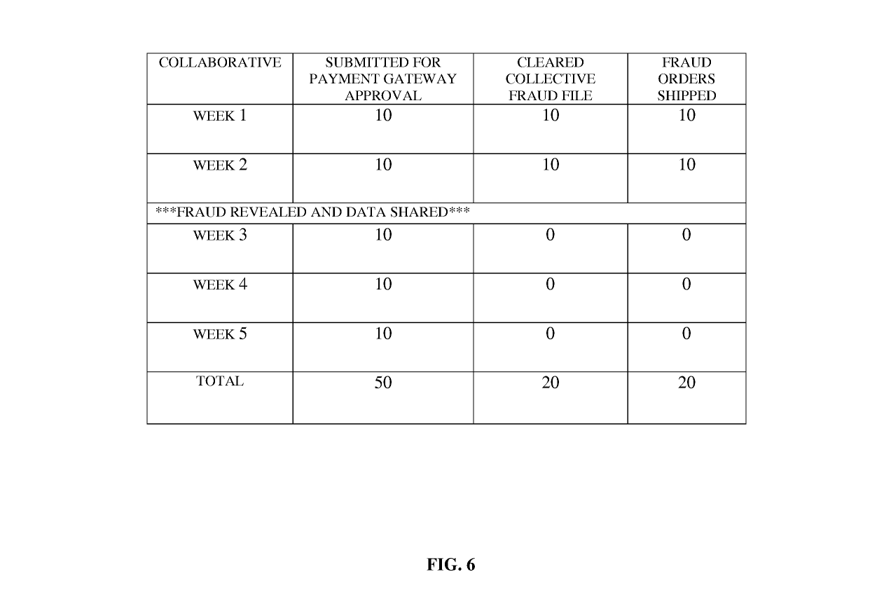

FIG. 6 exemplarily illustrates a tabular representation showing prevention of a fraudulent payment transaction in a collaborative environment by the collaborative fraud prevention platform. FIG. 6 shows that in weeks 1-2 of the transaction period of the shipment of the fraudulent payment transaction orders, 20 fraudulent payment transaction orders are approved by the payment gateway 502 exemplarily illustrated in FIG. 5, and that 20 fraudulent payment transaction orders are cleared or verified by the collaborative fraud prevention platform as non-fraudulent payment transactions and processed for shipment by merchant entities 401 exemplarily illustrated in FIGS. 4-5. The collaborative fraud prevention platform determines the fraudulent payment transaction in the third week of the transaction period of the shipment of the fraudulent payment transaction orders. The payment gateway 502 approves 10 fraudulent payment transaction orders in each week and transmits an approval message to the merchant entities 401. The collaborative fraud prevention platform transmits the fraud determination report to the merchant entities 401 indicating the fraudulent payment transaction. Hence, no fraudulent payment transaction orders are cleared by the collaborative fraud prevention platform in weeks 3-5 as the merchant entities 401 terminate or discontinue the processing of the fraudulent payment transaction orders. Hence, although the total number of the fraudulent payment transaction orders received by the merchant entities 401 from the fraudsters 501 exemplarily illustrated in FIG. 5 is 50, the total number of the fraudulent payment transaction orders processed and shipped by the merchant entities 401 is 20, thereby avoiding 60% of losses caused by the fraud.

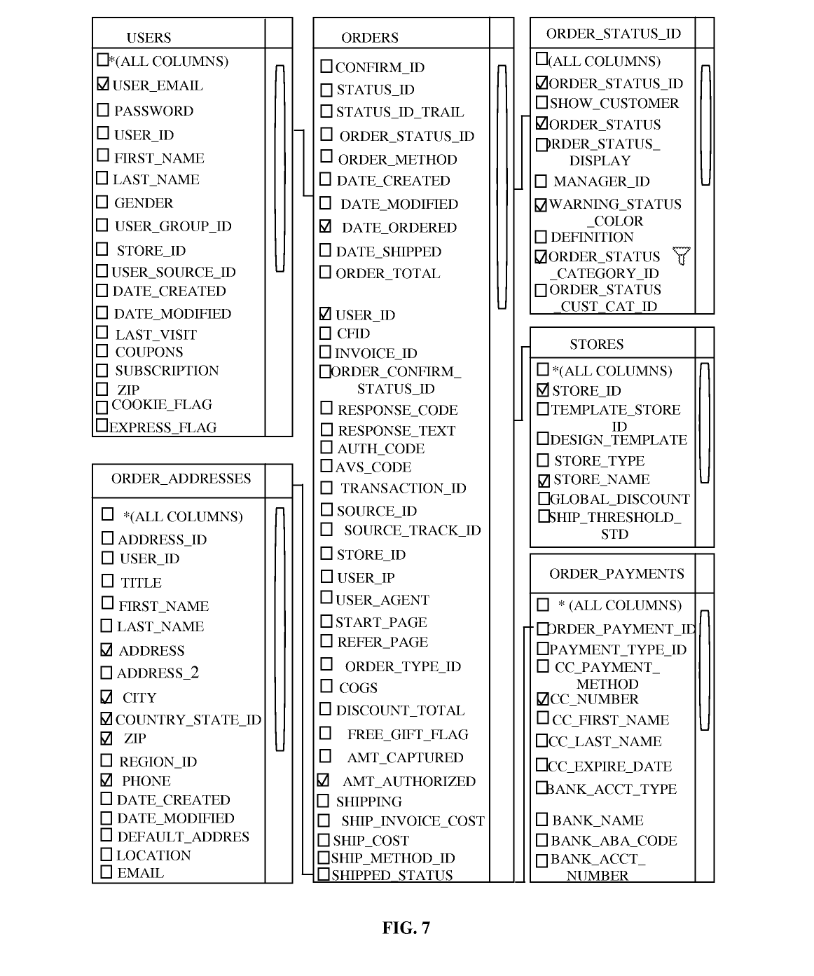

FIG. 7 exemplarily illustrates a schema of the collaborative database 409 shown in FIGS. 4-5 and FIG. 8, comprising multiple tables for storing transaction history data of multiple payment transactions received from multiple reviewing entities. The tables stored in the collaborative database 409 comprise, for example, an orders information table, a user or consumer information table, an address table, a payment type table, a merchant information table, an order status table, a consumer's internet protocol (IP) address table, etc. Each table in the collaborative database 409 comprises one or more data fields that are parsed and inserted into one or more tables upon the upload of transaction history data from the reviewing entities. In an embodiment, the tables are separately indexed and independently searchable to enable a reviewing entity to search for a single data field from a suspicious payment transaction data file. The collaborative database schema allows the reviewing entities to upload, store, modify, and search for transaction history data associated with fraudulent payment transactions and non-fraudulent payment transactions of products and/or services merchandised by the reviewing entities in a merchant market.

The orders information table comprises multiple data fields that store data items corresponding to transaction requests received or orders taken by merchant entities 401 exemplarily illustrated in FIGS. 4-5 via the collaborative fraud prevention platform. The data fields in the order information table store order based information comprising, for example, an order identification code generated by a merchant entity 401, an amount summary for the transaction request, a receipt date of the transaction request, etc. The consumer information table comprises multiple data fields that store data items corresponding to the consumer account that transmits the transaction requests to the merchant entities 401 via the collaborative fraud prevention platform. The data fields in the consumer information table store consumer based information comprising, for example, a first name of the consumer, a last name of the consumer, a merchant's identification code, etc. The consumer address table comprises multiple data fields that store data items corresponding to a physical billing address of the consumers who transmit the transaction requests to the merchant entities 401 via the collaborative fraud prevention platform. The data fields in the consumer address table comprise data items, for example, a shipping address for the transaction request, a billing address for the transaction request, etc. In an embodiment, the data fields of the consumer address table store multiple validity indicators provided by one or more third party entities to verify whether the billing addresses or the shipping addresses of the consumers match with addresses of the consumers as registered with a postal service, for example, the United States postal service, other delivery services, etc.

The payment type table comprises multiple data fields that store data items corresponding to a mode of payment used for the transaction requests. The data fields in the payment type table comprise data items, for example, a type of payment used by the consumer, a type of payment card used by the consumer, a card verification value (CVV or CVV2) code of the payment card used by the consumer for the payment of the transaction requests, etc. The merchant information table, also referred to as a “stores table”, comprises multiple data fields that store data items corresponding to types of merchant entities 401 that process the transaction requests via the collaborative fraud prevention platform. The data fields in the merchant information table store merchant based information comprising, for example, a merchant's name, a merchant's identification code, a sector type of the merchant entities 401, etc. The order status table comprises multiple data fields that store data items associated with types and statuses of the transaction requests that the merchant entities 401 receive from the consumers via the collaborative fraud prevention platform and upload to the collaborative database 409. The data fields in the order status table comprise, for example, stolen credit card information, improper returns of merchandised products in an event of a detected fraudulent payment transaction, fraudulent charge backs, etc.

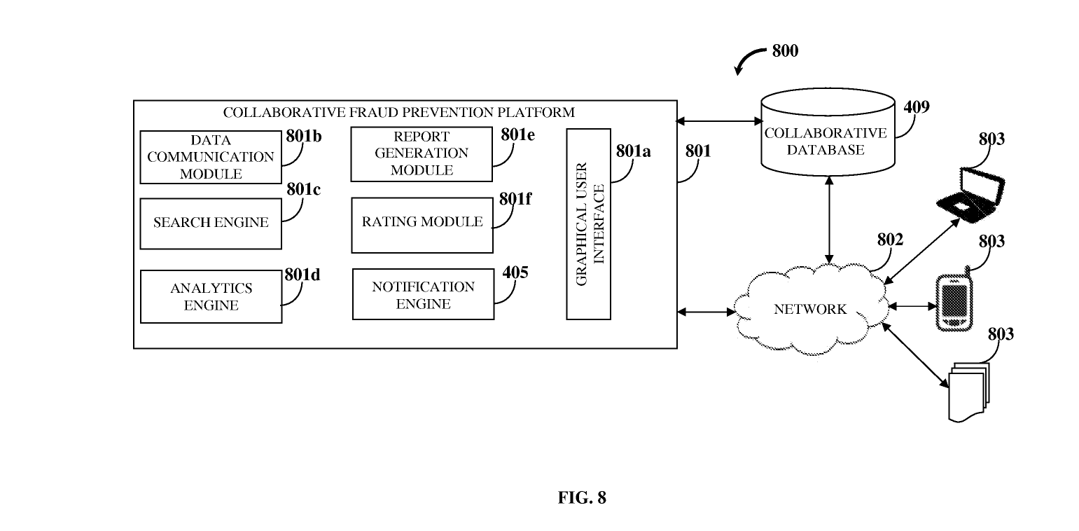

FIG. 8 exemplarily illustrates a computer implemented system 800 for determining a fraudulent payment transaction in a collaborative environment. The computer implemented system 800 disclosed herein comprises the collaborative database 409 and the collaborative fraud prevention platform 801. In another embodiment, the collaborative database 409 can be remotely accessed by the collaborative fraud prevention platform 801 via a network 802, for example, the internet. In another embodiment, the collaborative database 409 is operably and directly connected to the collaborative fraud prevention platform 801. The collaborative database 409 is accessible by computing devices 803 of multiple reviewing entities via the network 802. Each computing device 803 connected to the network 802 comprises a processor or a processing system. However, the exact configuration of the computing device 803 connected to the processor in each individual computing device 803 in the network 802 may vary. The collaborative database 409 collaboratively and dynamically receives and stores transaction history data comprising, for example, transaction information of the payment transactions, characteristics of consumer accounts engaged in the payment transactions, etc., from the reviewing entities. The reviewing entities upload the transaction history data to the collaborative database 409 using their computing devices 803. The collaborative database 409 further collaboratively and dynamically receives, stores, and updates account information of the reviewing entities and the consumer accounts engaged in the payment transactions in real time to facilitate enhanced accessibility by the reviewing entities.

The collaborative fraud prevention platform 801 is configured as a collaborative or crowd sourced fraud prevention system. The collaborative fraud prevention platform 801 comprises at least one processor and a non-transitory computer readable storage medium communicatively coupled to the processor. The processor is configured to execute modules, for example, 801b, 801c, 801d, 801e, 801f, 405, etc., of the collaborative fraud prevention platform 801. The non-transitory computer readable storage medium stores the modules, for example, 801b, 801c, 801d, 801e, 801f, 405, etc., of the collaborative fraud prevention platform 801. The collaborative fraud prevention platform 801 further comprises a graphical user interface (GUI) 801a, a data communication module 801b, a search engine 801c, an analytics engine 801d, and a report generation module 801e. The data communication module 801b receives a fraud determination query associated with a transaction request associated with a consumer account from the reviewing entity via the network 802 for determining authenticity or non-authenticity of the transaction request. The reviewing entity may enter the fraud determination query via the GUI 801a. The data communication module 801b further receives one or more fraud related parameters from the reviewing entity for configuring attributes of a fraud determination report for display on the GUI 801a. The reviewing entity may enter the fraud related parameters via the GUI 801a.

The GUI 801a provides access to the databases in the collaborative database 409 needed by the reviewing entities to both upload and download or search information related to fraudulent payment transactions. In an embodiment, the GUI 801a may be provided by software executed by the processor 901 at a computing device 803, for example, a desktop computer, a laptop computer, a tablet, a mobile device, or a smart phone, or may be executed by a server that is in communication with the network 802 using a browser or other access software. When a reviewing entity logs into the collaborative fraud prevention platform 801, the GUI 801a provides a display that will provide the reviewing entity with options. The GUI 801a displays options to upload, download, and search the information residing in the collaborative database 409. The reviewing entity can then select an option by clicking on the upload or search buttons for the option using a pointing device such as a computer mouse. In an embodiment, the GUI 801a displays various dropdown menus that may be scrolled through to select an option.

The search engine 801c performs a search in the collaborative database 409 based on the received fraud determination query by comparing current transaction data from the transaction request with the transaction history data stored in the collaborative database 409. The analytics engine 801d performs an analysis of the characteristics of the consumer account obtained from the stored transaction history data. In an embodiment, the analytics engine 801d further performs a real time analysis of one or more of account information of the reviewing entity, consumer account information, the transaction history data of the payment transactions, etc., stored in the collaborative database 409 for estimating multiple retail trends for dynamically updating, for example, fraud determination and prevention models, affiliated strategies, operations, staffing employed by the reviewing entity, etc.

The report generation module 801e dynamically generates a fraud determination report based on the comparison of the current transaction data from the transaction request with the stored transaction history data, and the analysis of the characteristics of the consumer account. The fraud determination report indicates the authenticity or the non-authenticity of the transaction request for configurable periods of time to enable the reviewing entity to determine the fraudulent payment transaction, and complete processing of the transaction request or discontinue the processing of the transaction request. In an embodiment, the report generation module 801e generates a fraud determination report that indicates the non-authenticity of the transaction request on immediate detection of the current transaction data associated with the stored transaction history data of a past fraudulent payment transaction, instructing the reviewing entity to discontinue the processing of the transaction request. In another embodiment, the report generation module 801e generates a fraud determination report that indicates the authenticity of the transaction request for a first period of time, for example, the first 2 weeks out of a predetermined 5 weeks for shipment of the transaction request, instructing the reviewing entity to continue the processing of the transaction request. In this embodiment, the report generation module 801e then generates a fraud determination report that indicates the authenticity or the non-authenticity of the transaction request on non-detection or detection of the current transaction data associated with the stored transaction history data of a past fraudulent payment transaction respectively for a second period of time, for example, the remaining 3 weeks out of the predetermined 5 weeks for shipment of the transaction request, instructing the reviewing entity to complete the processing of the transaction request or discontinue the processing of the transaction request respectively. In an embodiment, the report generation module 801e generates a white list of consumer accounts associated with non-fraudulent payment transactions based on inputs received from the reviewing entities for facilitating expeditious processing of future non-fraudulent payment transactions associated with the consumer accounts.

The collaborative fraud prevention platform 801 further comprises a rating module 801f for generating a reliability rating for each of the reviewing entities based on multiple rating parameters, for example, a volume of contributions, accuracy and quality of the contributed data, frequency of contributions by the reviewing entity, etc., associated with contributions of the transaction history data by each of the reviewing entities. The reliability rating of each of the reviewing entities assists other reviewing entities to assess reliability of the transaction history data contributed by each of the reviewing entities in the determination of the fraudulent payment transaction. The collaborative fraud prevention platform 801 further comprises the notification engine 405 for generating and transmitting notifications to the reviewing entities for performing multiple actions associated with, for example, the collaborative reception and storage of the transaction history data of the payment transactions received from the reviewing entities, the determination of the fraudulent payment transaction, completion or discontinuation of the processing of the transaction request.

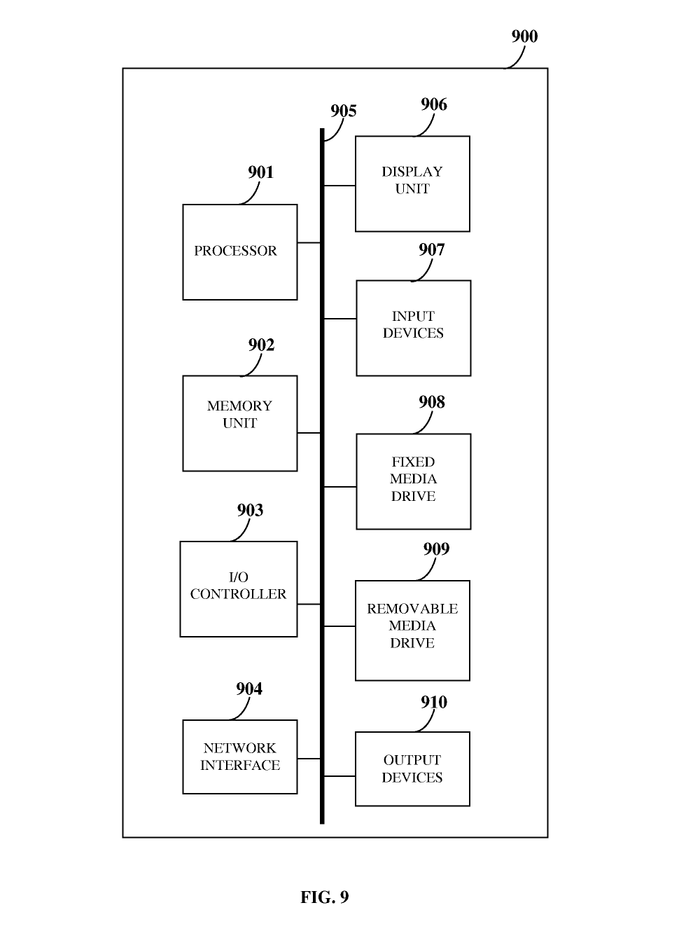

FIG. 9 exemplarily illustrates the architecture of a computer system 900 employed by the collaborative fraud prevention platform 801 for determining a fraudulent payment transaction in a collaborative environment. The collaborative fraud prevention platform 801 of the computer implemented system 800 exemplarily illustrated in FIG. 8 employs the architecture of the computer system 900 exemplarily illustrated in FIG. 9. The computer system 900 is programmable using a high level computer programming language. The computer system 900 may be implemented using programmed and purposeful hardware. The exact configuration and devices connected to the collaborative fraud prevention platform 801 in the network 802 may vary depending upon the operations that the collaborative fraud prevention platform 801 performs in the network 802.

The collaborative fraud prevention platform 801 communicates with the computing devices 803 of each of the reviewing entities, for example, merchant entities 401, as exemplarily illustrated in FIGS. 4-5, registered with the collaborative fraud prevention platform 801 via a network 802, for example, a short range network or a long range network. The computer system 900 comprises, for example, a processor 901, a non-transitory computer readable storage medium such as a memory unit 902 for storing programs and data, an input/output (I/O) controller 903, a network interface 904, a data bus 905, a display unit 906, input devices 907, a fixed media drive 908, a removable media drive 909 for receiving removable media, output devices 910, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 901 may also be implemented as a processor set comprising, for example, a general purpose microprocessor and a math or graphics co-processor. The processor 901 is selected, for example, from the Intel® processors such as the Itanium® microprocessor or the Pentium® processors, Advanced Micro Devices (AMD®) processors such as the Athlon® processor, UltraSPARC® processors, microSPARC™ processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The CPU is a processor, a microprocessor, or any combination of processors and microprocessor that execute instructions stored in the memory unit 902 to perform an application. The CPU is connected to a memory bus or the data bus 905 and the input/output (I/O) controller 903 or bus. The collaborative fraud prevention platform 801 disclosed herein is not limited to a computer system 900 employing a processor 901. The computer system 900 may also employ a controller or a microcontroller. The processor 901 executes the modules, for example, 801b, 801c, 801d, 801e, 801f, 405, etc., of the collaborative fraud prevention platform 801.

The memory unit 902 is a device for storing data onto a media. The memory unit 902 is used for storing programs, applications, and data. For example, the data communication module 801b, the search engine 801c, the analytics engine 801d, the report generation module 801e, the rating module 801f, the notification engine 405, etc., of the collaborative fraud prevention platform 801 are stored in the memory unit 902 of the computer system 900. The memory unit 902 is, for example, a random access memory (RAM) or another type of dynamic storage device that stores information and instructions for execution by the processor 901. A volatile memory such as the RAM is also connected to the processor 901 via the data bus 905. The RAM stores instructions for all processes being executed and data operated upon by the executed processes. Other types of memories such a dynamic random access memory (DRAM) and a static random access memory (SRAM) may also be used as a volatile memory and memory caches and other memory devices may be connected to the data bus 905. The memory unit 902 also stores temporary variables and other intermediate information used during execution of the instructions by the processor 901. The computer system 900 further comprises a read only memory (ROM) or another type of static storage device that stores static information and instructions for the processor 901. A non-volatile memory such as the ROM is connected to the processor 901 via the data bus 905. The ROM stores instructions for initialization and other system commands. Any memory that cannot be written to by the processor 901 may be used for the functions of the ROM. Other examples of the memory unit 902 comprise read/write compact discs (CDs) and magnetic disk drives.

The network interface 904 enables connection of the computer system 900 to the network 802. For example, the collaborative fraud prevention platform 801 connects to the network 802 via the network interface 904. The network interface 904 is, for example, a modem or an Ethernet card that connects the collaborative fraud prevention platform 801 to the network 802. In an embodiment, the network interface 904 is provided as an interface card also referred to as a line card. The network interface 904 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. Peripheral devices comprising, for example, the memory unit 902, the display unit 906, the input devices 907, the output devices 910, and the network interface 904 or the network connection device are connected to the processor 901 via the I/O controller 903. The I/O controller 903 carries data between peripheral devices and the processor 901. The I/O controller 903 controls input actions and output actions performed by the collaborative fraud prevention platform 801. The data bus 905 permits communications between the modules, for example, 801a, 801b, 801c, 801d, 801e, 801f, 405, etc., of the collaborative fraud prevention platform 801.

The display unit 906 is a monitor or a display with associated drivers that converts data to a display. The display unit 906, via the graphical user interface (GUI) 801a, displays information, display interfaces, user interface elements such as text fields, checkboxes, text boxes, windows, etc., for example, for allowing a reviewing entity to enter one or more fraud related parameters for configuring attributes of the fraud determination report for display on the GUI 801a. The display unit 906 comprises, for example, a liquid crystal display, a plasma display, an organic light emitting diode (OLED) based display, etc. The input devices 907 are used for inputting data into the computer system 900. The input devices 907 may be used by a reviewing entity to input data. The reviewing entities use input devices 907 to provide inputs to the collaborative fraud prevention platform 801. The input devices 907 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 900. The programs are loaded onto the fixed media drive 908 and into the memory unit 902 of the computer system 900 via the removable media drive 909. In an embodiment, the computer applications and programs may be loaded directly via the network 802. Computer applications and programs are executed by double clicking a related icon displayed on the display unit 906 using one of the input devices 907. The output devices 910 output the results of operations performed by the collaborative fraud prevention platform 801. For example, the collaborative fraud prevention platform 801 generates and displays fraud determination reports to the reviewing entities using the output devices 910.

The processor 901 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone® operating system of Microsoft Corporation, BlackBerry® operating system of Research in Motion Limited, the iOS operating system of Apple Inc., the Symbian® operating system of Symbian Foundation Limited, etc. The computer system 900 employs the operating system for performing multiple tasks. The operating system is responsible for management and coordination of activities and sharing of resources of the computer system 900. The operating system further manages security of the computer system 900, peripheral devices connected to the computer system 900, and network connections. The operating system employed on the computer system 900 recognizes, for example, inputs provided by the reviewing entities using one of the input devices 907, the output display, files, and directories stored locally on the fixed media drive 908, for example, a hard drive. The operating system on the computer system 900 executes different programs using the processor 901. The processor 901 and the operating system together define a computer platform for which application programs in high level programming languages are written.

The processor 901 retrieves instructions for executing the modules, for example, 801b, 801c, 801d, 801e, 801f, 405, etc., of the collaborative fraud prevention platform 801 from the memory unit 902. A program counter determines the location of the instructions in the memory unit 902. The program counter stores a number that identifies the current position in the program of each of the modules, for example, 801b, 801c, 801d, 801e, 801f, 405, etc., of the collaborative fraud prevention platform 801. The instructions fetched by the processor 901 from the memory unit 902 after being processed are decoded. The instructions are stored in an instruction register in the processor 901. After processing and decoding, the processor 901 executes the instructions. For example, the data communication module 801b defines instructions for receiving a fraud determination query associated with a transaction request associated with a consumer account, from the reviewing entity via the network 802 for determining authenticity or non-authenticity of the transaction request. Furthermore, the data communication module 801b defines instructions for receiving one or more fraud related parameters from the reviewing entity for configuring attributes of the fraud determination report for display on the GUI 801a. The search engine 801c defines instructions for performing a search in the collaborative database 409 based on the received fraud determination query by comparing current transaction data from the transaction request with the transaction history data stored in the collaborative database 409. The analytics engine 801d defines instructions for performing an analysis of the characteristics of the consumer account obtained from the stored transaction history data. Furthermore, the analytics engine 801d defines instructions for performing a real time analysis of one or more of account information of the reviewing entity, consumer account information, and the transaction history data of the payment transactions stored in the collaborative database 409 for estimating multiple retail trends for dynamically updating one or more of fraud determination and prevention models, affiliated strategies, operations, and staffing employed by the reviewing entity. The report generation module 801e defines instructions for dynamically generating a fraud determination report based on the comparison of the current transaction data from the transaction request with the stored transaction history data, and the analysis of the characteristics of the consumer account. Furthermore, the report generation module 801e defines instructions for generating a white list of consumer accounts associated with non-fraudulent payment transactions based on inputs received from the reviewing entities.

The rating module 801f defines instructions for generating a reliability rating for each of the reviewing entities based on multiple rating parameters associated with contributions of the transaction history data by each of the reviewing entities. The notification engine 405 defines instructions for generating and transmitting notifications to the reviewing entities for performing multiple actions associated, for example, with one or more of the collaborative reception and the storage of the transaction history data of the payment transactions received from the reviewing entities, determination of the fraudulent payment transaction, and completion or discontinuation of the processing of the transaction request.

The processor 901 of the computer system 900 employed by the collaborative fraud prevention platform 801 retrieves the instructions defined by the data communication module 801b, the search engine 801c, the analytics engine 801d, the report generation module 801e, the rating module 801f, the notification engine 405, etc., of the collaborative fraud prevention platform 801, and executes the instructions, thereby performing one or more processes defined by those instructions.

At the time of execution, the instructions stored in the instruction register are examined to determine the operations to be performed. The processor 901 then performs the specified operations. The operations comprise arithmetic operations and logic operations. The operating system performs multiple routines for performing a number of tasks required to assign the input devices 907, the output devices 910, and memory for execution of the modules, for example, 801b, 801c, 801d, 801e, 801f, 405, etc., of the collaborative fraud prevention platform 801. The tasks performed by the operating system comprise, for example, assigning memory to the modules, for example, 801b, 801c, 801d, 801e, 801f, 405, etc., of the collaborative fraud prevention platform 801, and to data used by the collaborative fraud prevention platform 801, moving data between the memory unit 902 and disk units, and handling input/output operations. The operating system performs the tasks on request by the operations and after performing the tasks, the operating system transfers the execution control back to the processor 901. The processor 901 continues the execution to obtain one or more outputs. The outputs of the execution of the modules, for example, 801b, 801c, 801d, 801e, 801f, 405, etc., of the collaborative fraud prevention platform 801 are displayed to the reviewing entities on the display unit 906.

For purposes of illustration, the detailed description refers to the collaborative fraud prevention platform 801 being run locally on the computer system 900; however the scope of the computer implemented method and system 800 disclosed herein is not limited to the collaborative fraud prevention platform 801 being run locally on the computer system 900 via the operating system and the processor 901, but may be extended to run remotely over the network 802 by employing a web browser and a remote server, a mobile phone, or other electronic devices. One or more portions of the computer system 900 may be distributed across one or more computer systems (not shown) coupled to the network 802.

Disclosed herein is also a computer program product comprising a non-transitory computer readable storage medium that stores computer program codes comprising instructions executable by at least one processor 901 for determining a fraudulent payment transaction in a collaborative environment. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 901, except for a transitory, propagating signal.

The computer program product comprises a first computer program code for collaboratively and dynamically receiving and storing transaction history data of multiple payment transactions from multiple reviewing entities in the collaborative database 409; a second computer program code for receiving a fraud determination query associated with a transaction request associated with a consumer account from a reviewing entity via the network 802 for determining authenticity or non-authenticity of the transaction request; a third computer program code for performing a search in the collaborative database 409 based on the received fraud determination query by comparing current transaction data from the transaction request with the transaction history data stored in the collaborative database 409; a fourth computer program code for performing an analysis of the characteristics of the consumer account obtained from the stored transaction history data; and a fifth computer program code for dynamically generating a fraud determination report based on the comparison of the current transaction data from the transaction request with the stored transaction history data and the analysis of the characteristics of the consumer account. In an embodiment, the computer program product disclosed herein further comprises a sixth computer program code for generating a reliability rating for each of the reviewing entities based on multiple rating parameters associated with contributions of the transaction history data by each of the reviewing entities; and a seventh computer program code for receiving one or more fraud related parameters from the reviewing entity for configuring attributes of the fraud determination report for display on the GUI 801a.

The computer program product disclosed herein further comprises one or more additional computer program codes for performing additional steps that may be required and contemplated for determining a fraudulent payment transaction in a collaborative environment. In an embodiment, a single piece of computer program code comprising computer executable instructions performs one or more steps of the computer implemented method disclosed herein for determining the fraudulent payment transaction in the collaborative environment. The computer program codes comprising computer executable instructions are embodied on the non-transitory computer readable storage medium. The processor 901 of the computer system 900 retrieves these computer executable instructions and executes them. When the computer executable instructions are executed by the processor 901, the computer executable instructions cause the processor 901 to perform the steps of the computer implemented method for determining the fraudulent payment transaction in the collaborative environment.

Consider an example where a reviewing entity, for example, a merchant entity 401 exemplarily illustrated in FIGS. 4-5 wishes to upload transaction history data associated with a fraudulent payment transaction encountered by the merchant entity 401. The merchant entity 401 accesses the collaborative fraud prevention platform 801 using computing devices 803, for example, desktop computers, laptop computers, etc., that connect to the network 802, for example, the internet, intranet, etc., via data paths, for example, telephone lines, Ethernet cables, wireless connections or any other manner of connecting processing systems. Any number of processors or processing units may also be connected to the network 802. The collaborative database 409 is connected to the network 802 via the data paths. The collaborative database 409 maintains, among others, a fraudulent payment transactions database, a non-fraudulent consumer database, a merchant database, etc. The fraudulent payment transactions database stores the transaction history data of the payment transactions that are found to be fraudulent or suspicious. This transaction history data is generally compiled by the merchant entities 401 and the compiled transaction history data is used to populate the fraudulent payment transactions database in the collaborative database 409. The non-fraudulent consumer order database stores the transaction history data of the payment transactions that are known to be non-fraudulent and can be expedited by the merchant entities 401 for the benefit of their known non-fraudulent consumers. This transaction history data is generally compiled by the merchant entities 401 and the compiled transaction history data is used to populate the non-fraudulent consumer order database in the collaborative database 409. The merchant database is a database that stores each merchant entity's 401 account information. The merchant entity's 401 account information stored in the merchant database comprises, for example, a merchant entity's 401 contact information, volume and quality of the transaction history data uploaded by the merchant entities 401, and frequency and volume of the transaction history data searched and downloaded by the merchant entities 401. The merchant entity's 401 account information may either be provided by the merchant entity 401 directly or by the collaborative fraud prevention platform 801 automatically.

The merchant entity 401 registers with and logs in to the collaborative fraud prevention platform 801 via the GUI 801a of the collaborative fraud prevention platform 801. In an embodiment, the login information is received either as a direct input from the merchant entity 401 or as an automated request from a third party web service configured to retrieve login information from a participating merchant entity 401. In an embodiment, the login information of the merchant entity 401 is manually reviewed and access to the collaborative fraud prevention platform 801 is granted. The collaborative fraud prevention platform 801 transmits a notification to the merchant entity 401 on a status of authentication to the collaborative fraud prevention platform 801. The collaborative fraud prevention platform 801 prompts the merchant entity 401 with instructions to upload transaction history data associated with a transaction request. In an embodiment, the merchant entity 401 uploads a single data file or multiple data files associated with one or more of fraudulent payment transactions, non-fraudulent payment transactions, and suspicious payment transactions. Once the upload of transaction history data is complete, the collaborative fraud prevention platform 801 checks the format of the uploaded transaction history data. In an embodiment, the collaborative fraud prevention platform 801 prompts the merchant entity 401 with a notification, if the format of the uploaded transaction history data is not as per the format predefined by the collaborative fraud prevention platform 801. In another embodiment, the collaborative fraud prevention platform 801 prompts the merchant entity 401 with a notification on successful upload of the submitted transaction history data to the collaborative database 409.

Consider another example where the merchant entity 401 wishes to search for a suspicious fraudulent payment transaction in the collaborative database 409 of the collaborative fraud prevention platform 801. As disclosed in the detailed description of FIG. 8, the collaborative database 409 comprises multiple tables with information relating to fraudulent payment transactions, non-fraudulent payment transactions, and suspicious payment transactions. The merchant entity 401 logs in to the collaborative fraud prevention platform 801 to confirm whether a suspicious payment transaction is fraudulent or non-fraudulent. The merchant entity 401 queries the collaborative database 409 to check whether a payment transaction received by the merchant entity 401 is a fraudulent payment transaction or a non-fraudulent payment transaction.

On successful authorization of a merchant entity 401 by the collaborative fraud prevention platform 801, the collaborative fraud prevention platform 801 transmits instructions to the merchant entity 401 to guide the merchant entity 401 on how to search in the collaborative database 409. Following instructions specified by the collaborative fraud prevention platform 801, the merchant entity 401 submits a fraud determination query to the collaborative database 409 as per the merchant entity's 401 requirement. The collaborative fraud prevention platform 801 processes the fraud determination query in the collaborative database 409 and generates a fraud determination report based on the search results provided by the collaborative database 409. The collaborative fraud prevention platform 801 transmits the fraud determination report to the merchant entity 401. In an embodiment, the merchant entity 401 can specify one or more fraud related parameters in a merchant entity account and submit the fraud related parameters to the collaborative fraud prevention platform 801 to receive a customized fraud determination report from the collaborative database 409. Depending on the fraud determination report received from the collaborative database 409 in response to the fraud determination query submitted by the merchant entity 401, the merchant entity 401 processes the received transaction request. If the fraud determination report indicates that a consumer associated with the received transaction request has a history of fraudulent payment transactions, then the merchant entity 401 discontinues processing of the received transaction request and uploads the data files associated with the received transaction request for use by other merchant entities 401 subscribed to the collaborative fraud prevention platform 801 for determination and prevention of the fraudulent payment transactions. If the fraud determination report indicates that the consumer associated with the received transaction request has a history of non-fraudulent payment transactions, then the merchant entity 401 adds the consumer of the received transaction request to a white list maintained by the collaborative fraud prevention platform 801 in the collaborative database 409, and processes the received transaction request, thereby expediting completion of processing of the received transaction request and earning goodwill of the consumer.

It will be readily apparent that the various methods, algorithms, and computer programs disclosed herein may be implemented on computer readable media appropriately programmed for computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Pascal, Perl®, Python®, Visual Basic®, hypertext preprocessor (PHP), etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the collaborative database 409, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, Hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Android® OS, the Blackberry® OS, the Solaris operating system developed by Sun Microsystems, Inc., or any other operating system. Handheld devices execute operating systems, for example, the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for determining a fraudulent payment transaction in a collaborative environment, comprising:
providing a collaborative fraud prevention platform comprising at least one processor configured to determine and prevent said fraudulent payment transaction;
generating a collaborative database accessible by a plurality of reviewing entities via a network for determining said fraudulent payment transaction, said collaborative database configured to collaboratively and dynamically receive and store transaction history data of a plurality of payment transactions from said reviewing entities, wherein said transaction history data comprises transaction information of said payment transactions and characteristics of consumer accounts engaged in said payment transactions;
receiving a fraud determination query associated with a transaction request associated with a consumer account, by said collaborative fraud prevention platform from a reviewing entity via said network for determining one of authenticity and non-authenticity of said transaction request;
performing a search in said collaborative database by said collaborative fraud prevention platform based on said received fraud determination query by comparing current transaction data from said transaction request with said transaction history data stored in said collaborative database;
performing an analysis of said characteristics of said consumer account obtained from said stored transaction history data by said collaborative fraud prevention platform; and
dynamically generating a fraud determination report by said collaborative fraud prevention platform based on said comparison of said current transaction data from said transaction request with said stored transaction history data, and said analysis of said characteristics of said consumer account, wherein said fraud determination report is configured to indicate said one of said authenticity and said non-authenticity of said transaction request for configurable periods of time to enable said reviewing entity to determine said fraudulent payment transaction and one of complete processing of said transaction request and discontinue said processing of said transaction request.

2. The computer implemented method of claim 1, wherein said fraud determination report is configured to indicate said non-authenticity of said transaction request on immediate detection of said current transaction data associated with said stored transaction history data of a past fraudulent payment transaction, instructing said reviewing entity to discontinue said processing of said transaction request.

3. The computer implemented method of claim 1, wherein said fraud determination report is configured to indicate said authenticity of said transaction request for a first period of time among said configurable periods of time, instructing said reviewing entity to continue said processing of said transaction request.

4. The computer implemented method of claim 1, wherein said fraud determination report is configured to indicate said one of said authenticity and said non-authenticity of said transaction request on one of non-detection and detection of said current transaction data associated with said stored transaction history data of a past fraudulent payment transaction respectively, for a second period of time among said configurable periods of time, instructing said reviewing entity to one of complete said processing of said transaction request and discontinue said processing of said transaction request respectively.

5. The computer implemented method of claim 1, further comprising generating a reliability rating for each of said reviewing entities by said collaborative fraud prevention platform based on a plurality of rating parameters associated with contributions of said transaction history data by said each of said reviewing entities, wherein said reliability rating of said each of said reviewing entities is configured to assist other said reviewing entities to assess reliability of said transaction history data contributed by said each of said reviewing entities in said determination of said fraudulent payment transaction.

6. The computer implemented method of claim 1, further comprising receiving one or more fraud related parameters from said reviewing entity by said collaborative fraud prevention platform for configuring attributes of said fraud determination report for display on a graphical user interface.

7. The computer implemented method of claim 1, further comprising generating a white list of said consumer accounts associated with non-fraudulent payment transactions by said collaborative fraud prevention platform based on inputs received from said reviewing entities, wherein said generated white list is configured to facilitate expeditious processing of future non-fraudulent payment transactions associated with said consumer accounts.

8. The computer implemented method of claim 1, wherein said generation of said collaborative database by said collaborative fraud prevention platform comprises:
extracting data items from said received transaction history data of said payment transactions; and
storing said extracted data items into data fields, wherein said data fields are configured to categorize said received transaction history data into a transaction category during said generation of said collaborative database, wherein said transaction category is one of a fraudulent transaction category, a non-fraudulent transaction category, and a suspicious transaction category.

9. The computer implemented method of claim 1, further comprising performing a real time analysis of one or more of account information of said reviewing entity, consumer account information, and said transaction history data of said payment transactions stored in said collaborative database by said collaborative fraud prevention platform for estimating a plurality of retail trends for dynamically updating one or more of fraud determination and prevention models, affiliated strategies, operations, and staffing employed by said reviewing entity.

10. The computer implemented method of claim 1, further comprising generating and transmitting notifications to said reviewing entities by said collaborative fraud prevention platform for performing a plurality of actions associated with one or more of said collaborative reception and said storage of said transaction history data of said payment transactions received from said reviewing entities, said determination of said fraudulent payment transaction, and said one of said completion and said discontinuation of said processing of said transaction request.

11. A computer implemented system for determining a fraudulent payment transaction in a collaborative environment, comprising:
a collaborative database accessible by a plurality of reviewing entities via a network for determining said fraudulent payment transaction, said collaborative database configured to collaboratively and dynamically receive and store transaction history data of a plurality of payment transactions from said reviewing entities, wherein said transaction history data comprises transaction information of said payment transactions and characteristics of consumer accounts engaged in said payment transactions; and
a collaborative fraud prevention platform comprising:
at least one processor configured to execute modules of said collaborative fraud prevention platform;
a non-transitory computer readable storage medium communicatively coupled to said at least one processor, said non-transitory computer readable storage medium configured to store said modules of said collaborative fraud prevention platform; and
said modules of said collaborative fraud prevention platform comprising:
a data communication module configured to receive a fraud determination query associated with a transaction request associated with a consumer account, from a reviewing entity via said network for determining one of authenticity and non-authenticity of said transaction request;
a search engine configured to perform a search in said collaborative database based on said received fraud determination query by comparing current transaction data from said transaction request with said transaction history data stored in said collaborative database;
an analytics engine configured to perform an analysis of said characteristics of said consumer account obtained from said stored transaction history data; and
a report generation module configured to dynamically generate a fraud determination report based on said comparison of said current transaction data from said transaction request with said stored transaction history data, and said analysis of said characteristics of said consumer account, wherein said fraud determination report is configured to indicate said one of said authenticity and said non-authenticity of said transaction request for configurable periods of time to enable said reviewing entity to determine said fraudulent payment transaction and one of complete processing of said transaction request and discontinue said processing of said transaction request.

12. The computer implemented system of claim 11, wherein said fraud determination report is configured to indicate said non-authenticity of said transaction request on immediate detection of said current transaction data associated with said stored transaction history data of a past fraudulent payment transaction, instructing said reviewing entity to discontinue said processing of said transaction request.

13. The computer implemented system of claim 11, wherein said fraud determination report is configured to indicate said authenticity of said transaction request for a first period of time among said configurable periods of time, instructing said reviewing entity to continue said processing of said transaction request.

14. The computer implemented system of claim 11, wherein said fraud determination report is configured to indicate said one of said authenticity and said non-authenticity of said transaction request on one of non-detection and detection of said current transaction data associated with said stored transaction history data of a past fraudulent payment transaction respectively, for a second period of time among said configurable periods of time, instructing said reviewing entity to one of complete said processing of said transaction request and discontinue said processing of said transaction request respectively.

15. The computer implemented system of claim 11, wherein said modules of said collaborative fraud prevention platform further comprise a rating module configured to generate a reliability rating for each of said reviewing entities based on a plurality of rating parameters associated with contributions of said transaction history data by said each of said reviewing entities, wherein said reliability rating of said each of said reviewing entities is configured to assist other said reviewing entities to assess reliability of said transaction history data contributed by said each of said reviewing entities in said determination of said fraudulent payment transaction.

16. The computer implemented system of claim 11, wherein said data communication module is further configured to receive one or more fraud related parameters from said reviewing entity for configuring attributes of said fraud determination report for display on a graphical user interface.

17. The computer implemented system of claim 11, wherein said report generation module is further configured to generate a white list of said consumer accounts associated with non-fraudulent payment transactions based on inputs received from said reviewing entities, wherein said generated white list is configured to facilitate expeditious processing of future non-fraudulent payment transactions associated with said consumer accounts.

18. The computer implemented system of claim 11, wherein said analytics engine is further configured to perform a real time analysis of one or more of account information of said reviewing entity, consumer account information, and said transaction history data of said payment transactions stored in said collaborative database for estimating a plurality of retail trends for dynamically updating one or more of fraud determination and prevention models, affiliated strategies, operations, and staffing employed by said reviewing entity.

19. The computer implemented system of claim 11, wherein said modules of said collaborative fraud prevention platform further comprise a notification engine configured to generate and transmit notifications to said reviewing entities for performing a plurality of actions associated with one or more of said collaborative reception and said storage of said transaction history data of said payment transactions received from said reviewing entities, said determination of said fraudulent payment transaction, and said one of said completion and said discontinuation of said processing of said transaction request.

20. The computer implemented system of claim 11, wherein said collaborative database is further configured to collaboratively and dynamically receive, store, and update account information of said reviewing entities and said consumer accounts engaged in said payment transactions in real time to facilitate enhanced accessibility by said reviewing entities.

21. A computer program product comprising a non-transitory computer readable storage medium, said non-transitory computer readable storage medium storing computer program codes that comprise instructions executable by at least one processor, said computer program codes comprising:
a first computer program code for collaboratively and dynamically receiving and storing transaction history data of a plurality of payment transactions from a plurality of reviewing entities in a collaborative database, wherein said transaction history data comprises transaction information of said payment transactions and characteristics of consumer accounts engaged in said payment transactions;
a second computer program code for receiving a fraud determination query associated with a transaction request associated with a consumer account from a reviewing entity via a network for determining one of authenticity and non-authenticity of said transaction request;
a third computer program code for performing a search in said collaborative database based on said received fraud determination query by comparing current transaction data from said transaction request with said transaction history data stored in said collaborative database;
a fourth computer program code for performing an analysis of said characteristics of said consumer account obtained from said stored transaction history data; and
a fifth computer program code for dynamically generating a fraud determination report based on said comparison of said current transaction data from said transaction request with said stored transaction history data, and said analysis of said characteristics of said consumer account, wherein said fraud determination report is configured to indicate said one of said authenticity and said non-authenticity of said transaction request for configurable periods of time to enable said reviewing entity to determine said fraudulent payment transaction and one of complete processing of said transaction request and discontinue said processing of said transaction request.

22. The computer program product of claim 21, further comprising a sixth computer program code for generating a reliability rating for each of said reviewing entities based on a plurality of rating parameters associated with contributions of said transaction history data by said each of said reviewing entities, wherein said reliability rating of said each of said reviewing entities is configured to assist other said reviewing entities to assess reliability of said transaction history data contributed by said each of said reviewing entities in said determination of said fraudulent payment transaction.

23. The computer program product of claim 21, further comprising a seventh computer program code for receiving one or more fraud related parameters from said reviewing entity for configuring attributes of said fraud determination report for display on a graphical user interface.
